(19) United States
(12) Patent Application Publication
(10) Pub. No.: US 2026/0197604 A1
(43) Pub. Date: Jul. 9, 2026

(54) SYSTEMS AND METHODS FOR PROVISIONING A SPATIO-TEMPORAL FEEDBACK BASED ON AN ACTIVITY

(71) Applicant: Neotericc LLC, LONE TREE, CO (US)

(72) Inventor: Patrick L. Carter, Lone Tree, CO (US)

(73) Assignee: Neotericc LLC, LONE TREE, CO (US)

(21) Appl. No.: 19/435,954

(22) Filed: Dec. 30, 2025

Related U.S. Application Data
(60) Provisional application No. 63/739,832, filed on Dec. 30, 2024.
(60) Provisional application No. 63/743,641, filed on Jan. 10, 2025.

(51) Int. Cl. H04W 4/02; G06F 3/01

(52) U.S. Cl. CPC H04W 4/026; G06F 3/011

(57) ABSTRACT

The present disclosure provides a method for provisioning a spatio-temporal feedback based on an activity. Further, the method may include receiving an activity data from a data source device. Further, the activity data may be associated with a performance of the activity. Further, the method may include analyzing the activity data using a spatial orientation model. Further, the spatial orientation model corresponds to a model representing a spatial orientation of an object associated with the activity. Further, the method may include determining a spatial characteristic data based on the analyzing. Further, the spatial characteristic data represents a spatial characteristic of the object. Further, the object includes a user. Further, the method may include generating a feedback data based on the determining of the spatial characteristic. Further, the method may include transmitting the feedback data to a user device associated with a user.

### REFERENCE TO RELATED APPLICATIONS

This application claims the benefit of U.S. Provisional Patent Application No. 63/739,832, titled “METHODS AND SYSTEMS FOR PROVISIONING SPATIO-TEMPORAL FEEDBACK BASED ON AN ACTIVITY”, filed on Dec. 30, 2024; and U.S. Provisional Patent Application No. 63/743,641, titled “METHODS AND SYSTEMS OF FACILITATING A CALIBRATION OF MULTIPLE CAMERAS”, filed on Jan. 10, 2025, each of which is incorporated by reference herein in its entirety.

### FIELD OF DISCLOSURE

The present disclosure relates to the field of data processing. More specifically, the present disclosure relates to systems and methods for provisioning a spatio-temporal feedback based on an activity.

### BACKGROUND

The field of computer-implemented spatial analysis technologies, including motion analysis and camera-based sensing, and more particularly to systems and methods for evaluating physical activity and spatial relationships in dynamic, real-world environments, is of significant importance in areas such as sports performance evaluation, training analytics, interactive systems, and distributed sensing applications, where accurate interpretation of movement and spatial context is essential for generating reliable feedback, insights, and decision support.

A desirable objective in the given field is to facilitate accurate, timely, and scalable evaluation of human movement and related spatial interactions while minimizing system complexity and user effort. In particular, a desirable aspect is to support real-time or near real-time performance assessment that reflects how individuals move during natural activity, that remains consistent across sessions and environments, and that may be deployed efficiently across varying hardware configurations. Achieving the said objective may enable actionable feedback, longitudinal analysis, and broader adoption of performance evaluation technologies in practical settings.

However, existing approaches face a number of challenges that hinder the achievement of the said objective. Many motion-based performance evaluation systems struggle to reliably capture and interpret complex three-dimensional movement, especially during rapid, multi-axis, or high-variability actions. The said limitations may result in unstable or inconsistent performance metrics, reduced sensitivity to subtle movement differences, and difficulty comparing performance across time or between individuals. In addition, some systems rely on rigid evaluation criteria or delayed post-processing, which may limit personalization, reduce responsiveness, and diminish the usefulness of feedback during active training or competition.

At the same time, systems that rely on camera-based spatial sensing often require burdensome calibration processes to establish consistent spatial relationships between cameras and the observed environment. Such processes may involve specialized calibration artifacts, repeated manual inputs, or expert intervention, increasing setup time and the likelihood of human-induced error. In scalable or distributed deployments, recalibration may become particularly inefficient when cameras are repositioned or added, and insufficient validation of calibration quality may allow spatial inaccuracies to persist undetected. The said issues may degrade the reliability of any downstream analysis that depends on accurate spatial alignment.

The integration of motion analysis with camera-based spatial sensing further amplifies the said challenges. Misalignment between sensing components, temporal inconsistencies, or calibration drift may propagate errors into movement interpretation and performance evaluation, reducing confidence in the resulting metrics. Existing solutions often lack a unified approach that addresses both robust movement evaluation and efficient spatial alignment, while also accommodating variability in users, environments, and system scale.

Therefore, there is a need for improved systems and methods for provisioning a spatio-temporal feedback based on an activity that may overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method for provisioning a spatio-temporal feedback based on an activity. Further, the method may include receiving, using a communication device, an activity data from a data source device. Further, the activity data may be associated with a performance of the activity. Further, the method may include analyzing, using a processing device, the activity data using a spatial orientation model. Further, the spatial orientation model corresponds to a model representing a spatial orientation of an object associated with the activity. Further, the method may include determining, using the processing device, a spatial characteristic data based on the analyzing. Further, the spatial characteristic data represent a spatial characteristic of the object. Further, the object includes a user. Further, the method may include generating, using the processing device, a feedback data based on the determining of the spatial characteristic. Further, the method may include transmitting, using the communication device, the feedback data to a user device associated with a user.

The present disclosure provides a system for provisioning a spatio-temporal feedback based on an activity. Further, the system may include a communication device. Further, the communication device may be configured for receiving an activity data from a data source device. Further, the activity data may be associated with a performance of the activity. Further, the communication device may be configured for transmitting a feedback data to a user device associated with a user. Further, the system may include a processing device communicatively coupled with the communication device. Further, the processing device may be configured for analyzing the activity data using a spatial orientation model. Further, the spatial orientation model corresponds to a model representing a spatial orientation of an object associated with the activity. Further, the processing device may be configured for determining a spatial characteristic data based on the analyzing. Further, the spatial characteristic data represent a spatial characteristic of the object. Further, the object includes a user. Further, the processing device may be configured for generating the feedback data based on the determining of the spatial characteristic.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

The drawings presented with this disclosure may illustrate representative and non-limiting arrangements of hardware components, software modules, artificial intelligence subsystems, machine learning architectures, data processing pipelines, user interfaces, network topologies, and memory arrangements that may be used to understand embodiments of the present subject matter. They may depict functional or conceptual layouts intended to facilitate explanation of the disclosed principles. The geometric appearance, dimensional proportions, ordering, grouping, and naming of elements within the drawings are not intended to imply any restriction on implementation. The drawings may schematically portray computing environments containing client devices, servers, distributed computing clusters, communication networks, storage systems, or artificial intelligence models arranged for training, inference, or combined operations. The drawings may include simplified symbolic representations of algorithmic processes, workflows, blocks, or modules; such symbolic representations are treated as abstractions of underlying hardware and software operations rather than literal structural requirements. Similarly, lines connecting components may represent logical associations, communication pathways, or data relationships rather than any specific physical wiring or layout. These figures may also illustrate non-exhaustive examples of operational stages, sequencing, or interactions among artificial intelligence components such as encoders, decoders, generators, discriminators, featurizers, transformers, or safety-validation modules. Any specific combination or configuration shown is presented for explanatory clarity only. Additional drawings, alternative views, or more granular depictions may be used without affecting the scope of the claims.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 is a block diagram illustrating a machine-learning system 300 for implementing various embodiments of this disclosure, in accordance with some embodiments.

FIG. 4 illustrates a flowchart of a method 400 for provisioning a spatio-temporal feedback based on an activity, in accordance with some embodiments.

FIG. 5 illustrates a flowchart of a method 500 for provisioning a spatio-temporal feedback based on an activity including generating, using the processing device 604, a personalized metric data, in accordance with some embodiments.

FIG. 6 illustrates a block diagram of a system 600 for provisioning a spatio-temporal feedback based on an activity, in accordance with some embodiments.

FIG. 7 illustrates a display device 700 showing the integration of spatio-temporal data, in accordance with some embodiments.

FIG. 8 illustrates a spatio-temporal mechanics of a player playing hockey, in accordance with some embodiments.

FIG. 9 illustrates a graph 900 of quaternion rotation dynamics, in accordance with some embodiments.

FIG. 10A illustrates a flowchart of a method 1000 of facilitating a calibration of multiple cameras, in accordance with some embodiments.

FIG. 10B illustrates a continuation of the flowchart of the method 1000 of facilitating a calibration of multiple cameras, in accordance with some embodiments.

FIG. 11 illustrates a flowchart of a method 1100 of facilitating a calibration of multiple cameras including generating, using the processing device 1204, a feedback data, in accordance with some embodiments.

FIG. 12 illustrates a block diagram of a system 1200 of facilitating a calibration of multiple cameras, in accordance with some embodiments.

FIG. 13 illustrates a flowchart of a method 1300 for streamlining calibration of multiple cameras, in accordance with some embodiments.

FIG. 14 illustrates a flowchart of a method 1400 for streamlining calibration of multiple cameras, including generating, using the processing device 1504, an activity-based data, in accordance with some embodiments.

FIG. 15 illustrates a block diagram of a system 1500 for streamlining calibration of multiple cameras, in accordance with some embodiments.

FIG. 16 illustrates a flowchart of a method 1600 for streamlining calibration of multiple cameras, including applying, using the processing device 1504, one or more of a confidence gating technique and a temporal smoothing technique to the activity-based feedback, in accordance with some embodiments.

FIG. 17 illustrates a table 1700 comprising time and effort savings, in accordance with some embodiments.

FIG. 18 illustrates a table 1800 comprising a comparison of calibration modes, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein as understood by the ordinary artisan based on the contextual use of such term differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

The detailed description that follows may provide a framework for describing computer-implemented systems, artificial intelligence systems, distributed learning infrastructures, data processing pipelines, and hardware and software arrangements suitable for implementing embodiments shown in the drawings. Terms such as processing, computing, determining, or generating refer to actions performed by computing systems or electronic devices that manipulate data represented as physical signals, stored values, or encoded information within registers, memory structures, and storage devices.

The present disclosure contemplates implementations involving artificial intelligence, machine learning, distributed computation, and computer-implemented systems operating upon data represented as physical electronic or optical signals. Descriptions of processing, analyzing, determining, transforming, encoding, decoding, generating, inferring, synthesizing, modifying, storing, retrieving, ranking, filtering, validating, classifying, or otherwise manipulating information are to be understood as referring to the actions of computing systems, electronic devices, or computational circuits that manipulate such signals in memory elements, registers, buffers, or storage media. These operations may be performed by general-purpose processors, specialized processors, machine learning accelerators, or combinations thereof.

The disclosure contemplates implementations in which artificial intelligence systems perform perception, synthesis, inference, prediction, or generation of information using models whose configurations may evolve based on training, feedback, or adaptive learning processes. A model may initially be configured with a set of parameters and architectural structures that define its behavior, and this configuration may change automatically as the model encounters training inputs, validation data, reference data, or instructor-provided feedback. A machine learning model may modify its internal state through optimization techniques, gradient updates, reinforcement signals, vector transformations, attention mechanisms, latent variable adjustments, embedding refinements, or other learning operations executed electronically. Such modifications may occur over extended cycles, partial cycles, or continual learning sequences without explicit intervention by a human.

The disclosure contemplates systems involving data ingestion pipelines that gather input from sources including but not limited to sensor signals, event streams, text data, image data, audio data, video data, structured and unstructured repositories, application logs, telemetric feeds, network services, or human-generated content. Ingestion functions may include filtering, normalization, augmentation, segmentation, batching, tokenization, windowing, compression, encryption, decryption, hashing, deduplication, contextualization, and mapping to internal formats. Intermediate components may transform this data into derived representations, including embeddings, latent encodings, feature tensors, multi-modal joint representations, or contextual vectors suitable for use by downstream modeling engines. These transformations may be performed using neural networks, statistical encoders, dimensionality-reduction algorithms, or hybrid computational modules.

The disclosure contemplates machine learning systems that may employ advanced architectures such as transformer networks, encoder-decoder stacks, mixture-of-experts structures, diffusion models, recurrent networks, convolutional hierarchies, attention-based models, retrieval-augmented architectures, cross-modal alignment engines, graph neural networks, probabilistic models, auto-encoding frameworks, or hybrid symbolic-neural systems. Such models may implement deep layers configured to perform operations including attention calculations, feed-forward projections, gating operations, positional encoding, normalization steps, multi-head routing, sequential decoding, or latent pathway selection. Multi-modal systems may combine textual, visual, auditory, sensory, or structured inputs within joint representational spaces. Embeddings may be learned from large corpora or multi-modal datasets and may encode semantic, syntactic, structural, temporal, spatial, or contextual relationships across modalities. These embeddings may be dynamically updated as the system encounters new information, thereby improving consistency, expressiveness, or alignment with real-world contexts.

The disclosure contemplates training processes that may involve supervised learning, unsupervised learning, semi-supervised learning, self-supervised learning, reinforcement learning, preference optimization, curriculum-based learning, active learning, or continual learning. Training operations may include forward passes through the model, backward propagation of gradients, update steps using optimization algorithms, adaptive learning-rate scheduling, regularization steps, loss-function evaluation, and check pointing of intermediate states. Training datasets may include real-world data, synthetic data, simulated data, augmented data, or mixtures thereof. Validation procedures may evaluate performance metrics, generalization behavior, safety constraints, or compliance with domain-specific criteria. In some implementations, refinement cycles may incorporate human-in-the-loop interventions, reward model shaping, safety evaluator feedback, or guided corrections.

The disclosure contemplates distributed or federated execution in which computation is partitioned across multiple hardware devices, regions, or clusters. Certain operations may occur at edge devices for low latency, while others may be delegated to remote servers, cloud clusters, datacenters, or specialized compute fabrics. Components may communicate over wired or wireless networks supporting data exchange, synchronization, replication, or model-state updates. Distributed learning processes may synchronize gradients, coordinate model versions, merge updates across shards, or exchange activation values within parallel training regimes. Distributed inference may involve routing requests across replicas, balancing load through orchestration layers, or selecting model pathways dynamically. Network connections may include encryption, authentication, secure session management, or routing protocols appropriate for maintaining privacy, integrity, or availability.

The disclosure contemplates orchestration layers capable of managing complex workflows involving model invocation, tool invocation, external data retrieval, decision routing, fallback selection, multi-model aggregation, post-processing evaluation, or safety governance. Orchestration environments may evaluate contextual signals, metadata, user characteristics, or policy constraints to determine which models, subsystems, or computational branches should be executed. Such environments may dynamically alter execution pathways based on estimated performance, resource availability, model confidence, safety risk, or real-time system health. Post-processing components may evaluate generated outputs for compliance with content policies, statutory requirements, operational constraints, or domain-specific decision rules.

The disclosure contemplates safety-oriented components that evaluate model outputs or intermediate representations for consistency with safety criteria, quality thresholds, regulatory considerations, factual accuracy constraints, domain restrictions, or alignment requirements. Safety modules may employ auxiliary models, discriminators, rule sets, statistical detectors, confidence estimators, or hybrid evaluators to identify undesirable outputs. These modules may trigger remediation actions including output modification, output rejection, re-routing through alternate inference pathways, invocation of corrective models, or escalation for human review. Safety processes may incorporate real-time validation, contextual scoring, adversarial robustness analysis, anomaly detection, or controlled generation constraints.

The disclosure contemplates governance structures including policy managers, audit loggers, compliance trackers, version controllers, and provenance systems that associate model outputs with contextual metadata, historical signals, update events, training sources, or safety evaluations. Systems may maintain lineage records documenting which model version, configuration state, or training dataset contributed to an outcome. Governance modules may ensure that system behavior aligns with formal requirements such as fairness principles, legal obligations, industry standards, or institutional guidelines.

The disclosure contemplates storage and memory systems capable of storing model parameters, datasets, embeddings, logs, metrics, checkpoints, execution traces, and auxiliary information used to configure or interpret model behavior. These storage systems may include magnetic media, semiconductor memory, optical media, solid-state arrays, distributed storage fabrics, or hybrid memory hierarchies. Storage media may contain instructions, configurations, or data structures that, when accessed by a computing device, configure that device to carry out the operations described herein. Such media may include executables, bytecode, machine code, firmware, microcode, program modules, configuration files, architectural descriptors, or schema definitions.

The disclosure contemplates user interfaces that permit human operators to view model outputs, initiate tasks, modify configurations, inspect metrics, interact with logs, evaluate safety signals, or guide system adaptation. Interfaces may be multimodal and may support textual input, speech commands, visual interaction, gesture control, or programmatic invocation through APIs. Administrative interfaces may allow for reviewing system performance, tuning operational thresholds, enabling or disabling features, monitoring resource use, examining generated content, or initiating refinement workflows.

The disclosure contemplates systems in which instructions are executed entirely on a single device, partially on multiple devices, or cooperatively across remote and local environments. Code may execute directly on hardware, within firmware, inside virtual machines, inside containers, or through any combination of software and hardware interactions. Computational instructions may be stored locally, transferred via communication networks, or streamed from remote systems. Implementations may involve software executing on general-purpose processors, specialized logic circuits performing equivalent functions, or hybrid mechanisms that combine hardware acceleration with software guidance.

Interpretation of terms in this disclosure is governed by principles commonly applied by persons of ordinary skill in the relevant field. Technical and scientific terms used herein should be understood in a manner consistent with their usage in the field of artificial intelligence, machine learning, computing, networking, data storage, or any related discipline. Terms describing functionality should not be interpreted as strictly structural unless explicitly stated. Phrases such as configured to, adapted to, operable to, or capable of indicate permissible functionality rather than structural limitations. Terms such as a or an encompass one or more unless clearly contradicted by context. Terms joined by or should be interpreted as inclusive, and terms joined by and should be interpreted as collective.

The description set forth herein provides a broad and flexible framework intended to support a wide range of computer-implemented, machine-learning-enabled, distributed, and multimodal embodiments. Variations may include reallocation of tasks, substitution of algorithms, reconfiguration of models, changes to pipeline ordering, or adoption of alternate hardware. No combination or arrangement mentioned herein should be regarded as required unless explicitly stated. The scope of protection is established by the claims, interpreted in light of this description.

The present disclosure contemplates implementations that employ advanced mathematical frameworks characteristic of modern artificial intelligence systems. Machine learning models may be conceptualized as parameterized functions that map elements of an input space to elements of an output space. Such a function may be defined over real-valued, complex-valued, vector-valued, tensor-valued, or mixed-modal domains. The model may implement successive transformations applied to an ordered set of input vectors using compositions of linear operators, nonlinear activations, attention functions, normalization operations, and dimensional projections.

Model parameters may be represented as ordered collections of real-valued scalars arranged into structures such as matrices, tensors, kernels, filters, or embeddings. These parameters may be optimized by minimizing a loss functional defined over an expected distribution of input-output pairs. The optimization process may involve computing gradients of the loss functional with respect to each model parameter, followed by an update step that serves to reduce the value of the loss functional. Gradient computation may use automatic differentiation frameworks that symbolically or numerically propagate partial derivatives backward through a computational graph.

Attention mechanisms may employ a similarity measure between projected query vectors and projected key vectors. This similarity measure may yield a weight distribution over contextual elements. The weighted combination of projected value vectors may form an attention output that is subsequently transformed through additional layers. Multiple independent attention heads may be aggregated to capture heterogeneous relationships within the input domain. Cross-attention mechanisms may operate similarly but with distinct source and target sequences.

Normalization steps may rescale intermediate representations using learned scaling and shifting coefficients. Activation functions may introduce nonlinearity by applying element-wise transformations selected to ensure differentiability and expressive capacity. Residual pathways may combine transformed and untransformed representations to facilitate stable gradient propagation under deep compositions. Positional encodings or structural embeddings may inject ordering, spatial, temporal, or relational information into otherwise permutation-invariant architectures.

Multi-modal models may operate over domains that combine text, image, audio, video, sensor, or structured signals. These domains may be embedded into a common vector space through learned projection operators. Joint training processes may enforce alignment constraints that minimize representational divergence between modalities while preserving intra-modal semantics.

Diffusion frameworks may model data generation as the reversal of a stochastic corruption process. A forward process may incrementally add noise to data samples, while a learned reverse process may approximate the time-reversed conditional probability distribution. The reverse process may be parameterized by a neural network trained to denoise intermediate states. Continuous-time formulations may model this process using stochastic differential equations whose drift and diffusion terms are learned through score-matching or related techniques.

Reinforcement-based procedures may model learning as an optimization of expected reward under a policy function. The policy may produce distributions over actions given a latent or explicit representation of the environment state. Policy gradients may be estimated from sampled trajectories, and advantage estimators may reduce the variance of such gradients. Value functions may approximate the expected cumulative reward, and these approximations may be updated through temporal-difference learning.

Generative models may be expressed in probabilistic terms as joint or conditional distributions parameterized by neural architectures. Such models may perform sampling by iteratively drawing latent variables from a learned distribution and transforming those variables into output space. Variational models may introduce auxiliary latent variables whose posterior distributions are approximated through recognition functions that optimize an evidence-bound objective.

Matrix decompositions, spectral analysis, manifold learning, kernel operators, and other mathematical constructs may be incorporated to improve expressiveness, stability, or computational efficiency. Training may involve sophisticated schedulers, trust-region constraints, adaptive learning-rate schemes, gradient-norm clipping, regularization penalties, entropy maximization, attention masking, or mixed-precision arithmetic.

All such mathematical constructs are conceptual, descriptive, and non-limiting. The disclosure encompasses any differentiable or non-differentiable optimization method, any discrete or continuous learning paradigm, and any representational transformation that may be understood by a person of ordinary skill in the field.

Further, the disclosure provides a computing environment which may include a combination of client devices, servers, distributed computing clusters, databases, external data sources, network nodes, and interface endpoints. Such an environment may support artificial intelligence workloads including perception, synthesis, inference, prediction, and generation, using hardware and software foundations designed for high-throughput and low-latency operation. Embodiments may involve the coordinated use of multiple machine learning models, whose configurations may evolve over time as they learn from training, validation, reference, or feedback data. Models may adjust their internal parameters through supervised, unsupervised, or reinforcement-based processes, allowing automatic electronic improvements to their performance based on input data and observed outcomes.

Further, the disclosure provides a computing device which may include processing units, memory elements, storage devices, system buses, high-speed controllers, low-speed controllers, and expansion interfaces. Processors may include general-purpose units, multi-core processors, vector processors, digital signal processors, tensor accelerators, neural accelerators, graphics engines, or various kinds of specialized integrated circuits including FPGAs, ASICs, ASSPs, SoCs, and CPLDs. A device may include system memory composed of volatile or non-volatile components such as RAM, DRAM, flash memory, ROM, or phase-change memory. The storage subsystem may include solid-state drives, magnetic disks, optical media, arrays of storage devices, and network-attached storage resources. Input and output mechanisms may include microphones, displays, keyboards, pointing devices, biometric sensors, gesture or touch interfaces, and actuators suitable for multimodal interaction with a user.

Further, the disclosure provides a machine-learning architecture which may include engines or modules such as a data input engine, data retrieval engine, data transform engine, featurization engine, modeling engine, generative engine, validation engine, feedback engine, and refinement engine. A data input pipeline may obtain structured or unstructured information from various sources, transform the information into model-compatible forms, and store such transformed data in memory or storage accessible to downstream components. A modeling engine may perform tasks such as model training, re-configuration, validation, and testing, executing iterative processes across multiple cycles or passes through training data. A predictive or generative engine may construct outputs based on intermediate representations, learned embeddings, or latent encodings generated by layers such as encoder-decoder structures, attention mechanisms, or multi-layer transformer architectures. Embeddings may represent discrete entities such as words, documents, or images as continuous vectors in high-dimensional spaces, capturing semantic or structural relationships useful for downstream tasks.

Further, the disclosure may provide that a distributed or cloud-based operation may include multiple physical or virtual instances of computing devices, distributed across data centers or network boundaries. Functions may be partitioned across machines to achieve parallelism, redundancy, fault tolerance, or improved throughput. Distributed systems may use load balancing mechanisms to maintain stable processing, memory, or bandwidth utilization across clusters and avoid overload conditions. Such deployments may require communication over wired or wireless networks that implement a variety of protocols, including HTTP, HTTPS, MQTT, CoAP, or any other suitable communication framework. Communication channels may include local networks, wide-area networks, personal-area networks, or global communication systems, potentially utilizing secure, encrypted sessions such as SSL-based channels.

Further, the disclosure may provide an algorithm, process, or flow diagram which may include operations that may occur in sequences, reversed orders, concurrently, or in partially overlapping timelines, depending on the implementation. Blocks representing actions in a flowchart may correspond to program modules, instruction sequences, or hardware logic capable of performing the specified acts. Such operations may manipulate physical quantities such as electrical or magnetic signals stored or transferred among memory units, registers, storage devices, or communication media. Flow diagrams may be realized through software running on general-purpose processors, through dedicated hardware circuits, or through combinations of both.

Further, the disclosure may provide memory, storage, or programmatic constructs which may include program instructions encoded on computer-readable media including electronic, magnetic, optical, electromagnetic, semiconductor, or other tangible media. Examples include RAM, ROM, EEPROM, flash memory, magnetic disks, optical disks, and mechanical encoded structures such as punch cards or raised-pattern media. Such storage media may store instructions that, when executed, configure the memory and therefore configure the computing device itself, causing the device to perform functions described in association with the drawings.

Further, the disclosure may provide a user interface which may include graphical displays, dashboards, selection controls, input fields, monitoring elements, or multimodal interaction surfaces, allowing users to interact with computing systems in speech, touch, gesture, or other modalities. Such interfaces may be presented through client devices, server applications, or remote access platforms and may support visualization of model behavior, systems performance, or configuration parameters.

Further, the described features may be combined, rearranged, omitted, or substituted without departing from the principles disclosed. Variations may involve distributing functionality across devices, merging components, implementing features in hardware rather than software, or employing alternative communication protocols. Many such variations and modifications are intended to fall within the scope of the disclosure as understood by persons skilled in the art.

The detailed description of the drawings, therefore, provides a foundation for describing technical, architectural, and operational aspects of embodiments, while allowing broad flexibility in how such embodiments may be implemented in practice. The scope of such embodiments is governed by the claims rather than the illustrative content of the drawings.

In some embodiments, a system consistent with this disclosure includes one or more client devices, one or more servers, and one or more data stores coupled by one or more networks. The client devices can include, without limitation, mobile phones, tablet computers, laptop or desktop computers, wearable devices, smart displays, vehicles, robots, or other computing platforms equipped with data processing hardware and memory hardware. The servers can include data servers, application servers, web servers, proxy servers, or cloud computing services that provide shared processing, storage, and networking resources. The data stores can include databases, object stores, file systems, or other repositories that persist configuration data, training data, logs, model artifacts, and other information.

The networks can include public and private networks, such as local area networks, wide area networks, and cloud networks, using wired or wireless communication links. The networks can provide routing, addressing, access control, encryption, and related functionality using standard or proprietary protocols.

Each computing device, whether a client device or a server, can include one or more processors, system memory, persistent storage, communication interfaces, and input or output devices. The processors can include general purpose central processing units, graphics processing units, digital signal processors, microcontrollers, application specific integrated circuits, field programmable gate arrays, or other programmable or fixed function processing elements configured to execute instructions or perform logic operations. The memory can include volatile and non-volatile storage, such as random access memory and read only memory. The persistent storage can include solid state drives, magnetic disks, optical media, or other non-transitory computer-readable media.

Program code executed by the processors can include operating systems, device drivers, libraries, and application programs, including components that implement portions of the methods described herein. Program code and data can be stored on computer-readable media and loaded into memory by standard mechanisms, such as boot loaders, installation programs, or update services.

Input devices can include keyboards, pointing devices, microphones, cameras, touch-sensitive surfaces, biometric sensors, and other sensors. Output devices can include displays, speakers, haptic devices, printers, and other actuators. Some devices can support multimodal interaction, allowing combined or sequential input and output through various modalities.

For purposes of this disclosure, artificial intelligence systems may include arrangements of software and hardware that perform tasks such as perception, prediction, planning, or generation based on input data. These systems can employ one or more models, such as statistical models, neural networks, decision trees, or other machine learning models. As used herein, a “model” can refer to a parameterized function, an ensemble of such functions, or a collection of cooperating components that process data and produce outputs.

In some embodiments, the system includes a data input engine that obtains data from one or more sources, such as application logs, sensor streams, structured databases, and unstructured content. The data input engine can retrieve, filter, aggregate, or transform the data into feature representations suitable for model consumption. Data sources can include training data, validation data, and reference data used to evaluate and calibrate model behavior.

A modeling engine can manage one or more training processes for one or more models. The modeling engine can select model architectures, initialize parameters, and apply training algorithms such as supervised learning, semi supervised learning, unsupervised learning, reinforcement learning, or combinations thereof. The modeling engine can also manage hyper parameters, training schedules, and evaluation procedures across epochs or passes through the data.

The system can include a generative response engine or inference engine that receives prompts or other inputs and generates outputs using one or more models. For example, a natural language interface can receive a text prompt, embed or otherwise encode the prompt, process the encoded prompt using a transformer based model or other sequence model, and generate a sequence of tokens that are decoded into an output. The engine can generate multiple candidate outputs and apply validation or ranking logic to select a final result according to quality, safety, or relevance criteria.

A feedback engine can collect explicit or implicit feedback signals, such as user ratings, corrective edits, or outcome metrics derived from downstream tasks. A refinement engine can use such feedback to adjust model parameters, routing logic, or policies, for example by performing additional training steps, updating reward models, or modifying configuration parameters.

In certain embodiments, the disclosed techniques are applied to platforms that include sensors and actuators, such as vehicles, robots, or other machines. The platform can include a processor system that receives signals from cameras, LIDAR units, radar units, inertial sensors, and other devices, and produces control outputs for steering, propulsion, braking, or other actuators. Sensor data can be captured at various sampling rates and processed by perception models to detect and track objects and infer scene attributes.

Planning and control components can receive outputs from perception models along with route information, traffic rules, and high-level goals. These components can generate trajectories or control commands, optionally using reinforcement learned policies, optimization-based planners, or hybrid systems. Connections to backend services can permit off-board processing, fleet-level learning, or remote supervision where appropriate, while on-board components can maintain safe operation in the presence of network latency or failures.

The systems described herein can be implemented using centralized, decentralized, or hybrid arrangements. For instance, models may be deployed in cloud environments, on edge devices, or across both, depending on requirements such as latency, privacy, cost, and reliability. Load balancing and resource management components can distribute processing across devices or data centers and can provide elasticity to accommodate changing workloads.

Certain embodiments may expose functionality through application programming interfaces, software development kits, or graphical user interfaces. Client applications can submit requests to backend services, which can apply authentication, authorization, logging, and policy enforcement before invoking models or tools and returning results.

The systems and methods disclosed herein can be implemented in hardware, software, firmware, or any combination thereof. In some embodiments, operations are carried out by one or more processors executing program instructions stored on one or more non-transitory computer-readable media. Such media can include, without limitation, semiconductor memory, magnetic storage, optical storage, and combinations thereof. Program instructions, when executed by the processors, cause the processors to perform the operations described herein.

Instructions can be delivered to computing devices in various ways, such as pre-installation, physical distribution of media, or transmission over networks. Instructions received over a network can be stored in memory or persistent storage and then executed by one or more processors. Dedicated hardware logic, such as application specific integrated circuits or field programmable gate arrays, can be used alone or in combination with software to implement certain functionality.

Any methods described in connection with embodiments of the present disclosure can be represented as one or more flow diagrams or state diagrams. Blocks in such diagrams can correspond to modules, components, operations, or code segments that implement the associated functionality. Blocks can be reordered, combined, executed concurrently, or omitted according to implementation-specific considerations, unless a particular ordering is required by the claims.

Examples and embodiments described herein illustrate, rather than limit, the claimed subject matter. Certain features have been described in connection with particular embodiments for clarity, but other embodiments can include such features in different combinations. Features described in separate embodiments can be combined, and features described in a single embodiment can be separated, unless such combinations or separations are inconsistent with the claims. The scope of the disclosure is defined by the claims and their equivalents.

### Overview

The present disclosure introduces a spatial orientation framework that leverages advanced orientation models, such as quaternions, to accurately track joint movements and body alignment in 3D space. The system ensures smooth, precise tracking without gimbal lock, capturing both rotational and positional transitions across various sports scenarios. The given framework not only measures and analyzes movements like wrist and shoulder rotations in basketball but also applies across other sports, such as tracking player body shifts in football or goalie positioning in hockey. Integrated with adaptive scoring models, the disclosed system delivers real-time feedback and performance insights tailored to each athlete's needs.

Further, in some embodiments, the present disclosure may describe the following features:
1. System for Capturing Joint Movements and Body Alignment
A system for tracking joint movements and body alignment in real time using spatial orientation models, including quaternions and other advanced 3D mathematical techniques.
2. Method for Computing Rotational and Positional Transitions:
A method for calculating both rotational and positional transitions of joints across different phases in sports scenarios, ensuring accurate tracking without gimbal lock.
3. Integration with Adaptive Scoring Models:
Integration of spatial orientation metrics with adaptive scoring frameworks to deliver continuous, personalized feedback based on individual performance.
4. Multi-Sport Application of Spatial Orientation Models:
A method for evaluating rotational and positional performance across various sports, such as basketball shot phases (e.g., transfer, pocket, release), football body shifts, and goalie positioning in hockey.

Further, the present disclosure relates to systems and methods for capturing, tracking, and evaluating spatial orientation and movement in sports performance. Specifically, the disclosed system applies spatial orientation models, including quaternions and other 3D mathematical frameworks, to analyze joint movements, body alignment, and rotational transitions to provide real-time feedback on athletic performance. The present disclosure aims to overcome the limitations of existing systems by introducing a spatial orientation framework, using models such as quaternions, to evaluate sports performance in 3D space.

Further, the present disclosure introduces a system for capturing, tracking, and evaluating joint movements and body alignment using spatial orientation models like quaternions. Further, the disclosed system ensures smooth, continuous tracking of rotational transitions without gimbal lock and integrates the said metrics with adaptive scoring frameworks to deliver dynamic performance feedback in real-time.

Further, by focusing on spatial orientation, the system allows athletes to evaluate and improve movements, such as wrist rotations, shoulder alignment, and positional shifts, with unprecedented precision. The given system is designed to work seamlessly across multiple sports scenarios, providing personalized metrics and adaptive insights based on the athlete's movements.

Further, in some embodiments, the present disclosure may have the following aspects:
1. System for Spatial Orientation Tracking:
A system for capturing joint movements and body alignment in real time using spatial orientation models, including quaternions and other 3D mathematical frameworks.
2. Method for Computing Rotational and Positional dynamic/s:
A method for identifying and computing rotational and positional transitions of joints across phases, ensuring smooth tracking without gimbal lock.
3. Integration with Adaptive Scoring Frameworks:
Integration of spatial orientation metrics with adaptive scoring frameworks to generate real-time feedback tailored to individual performance.
4. Dynamic Feedback Based on Positional Shifts:
A method for delivering dynamic feedback using performance metrics based on both rotational and positional data for improved athletic training.
5. Multi-Sport Application of Spatial Orientation Models:
Application of the spatial orientation system across multiple sports scenarios, such as tracking a basketball shot's phases, football player rotations, or a goalie's positioning in hockey.

Further, the system leverages spatial orientation models like quaternions to accurately capture joint movements and body alignment in 3D space. Quaternions provide a robust mathematical framework for describing rotations, preventing issues like gimbal lock that may occur with other orientation models, such as Euler angles.

Further, in some embodiments, the present disclosure may describe the following features:
1. Spatial Orientation Tracking of Joints and Body Alignment
The disclosed system captures precise movements of joints such as wrists, shoulders, hips, and knees throughout athletic activities. The system applies quaternion models to smoothly monitor transitions between rotational states, ensuring that even rapid or complex movements are accurately captured. For example, in basketball, the system may track the shoulder rotation during a shot's transfer, pocket, and release phases.
2. Real-Time Computation of Rotational and Positional Transitions
The system computes rotational and positional shifts dynamically, capturing both micro-level movements (e.g., wrist rotations) and macro-level changes (e.g., full-body alignment). The said metrics are used to evaluate and refine performance in real-time, enabling athletes and coaches to monitor progress during both practice and competitive settings.

3. Integration with Adaptive Scoring Frameworks
The spatial orientation data is integrated with adaptive scoring models to provide continuous feedback. Further, the scores are adjusted based on detected movements and situational context, delivering personalized performance metrics. For instance, in basketball, the system may adjust scoring criteria based on a player's shooting angle or wrist rotation during the release phase.
4. Multi-Sport Application
The system's flexibility allows the system to be applied across various sports. For example:
   Basketball: Tracks rotational shifts during a shot, evaluating wrist and shoulder movements through phases like transfer, pocket, and release.
   Football: Monitors player body rotations and directional shifts during throws or runs.
   Hockey: Evaluates goalie movements and positioning based on rotational transitions within the defensive zone.

Further, the adaptability of the spatial orientation framework ensures the system remains relevant across a wide range of sports performance scenarios.

Further, in some embodiments, the present disclosure introduces a novel spatial orientation framework for tracking joint movements and body alignment in sports performance. By leveraging quaternion models and other advanced 3D mathematical techniques, the system delivers smooth, precise tracking without gimbal lock. Integrating the said spatial orientation metrics with adaptive scoring frameworks provides personalized feedback and insights in real-time, enhancing training and performance evaluation across multiple sports.

Further, the disclosed system's flexibility makes the system applicable to a wide range of sports scenarios, such as evaluating wrist and shoulder movements in basketball, monitoring player body rotations in football, and analyzing goalie positioning in hockey. The given robust and adaptive platform ensures athletes and coaches receive actionable feedback tailored to individual performance needs, facilitating continuous improvement and competitive success.

Further, the disclosed method and system may analyze a sports equipment (e.g., balls, hockey sticks, baseball bats, etc.) in addition to the biomechanical data for human motion. The sports equipment is as integral to athletic performance as the athlete's biomechanics, yet existing systems may not capture the same. For instance:
Golf: While some systems visualize body key points, they fail to track and represent the club and the club's interaction with the swing plane.
Hockey: The stick's position and interaction with the puck are critical for shot accuracy and passing mechanics.
Basketball: Tracking both the ball's trajectory and player motion allows for comprehensive analysis of dribbling, shooting, and passing mechanics.

Further, in some embodiments, the present disclosure describes the following features:
1. Equipment Integration in 3D Models:
The disclosed system may incorporate sports equipment into 3D spatial analyses, ensuring that the sports equipment is represented as part of the biomechanical and situational evaluations. Quaternions or similar methods may track rotations and interactions between the athlete and equipment.
2. Composite Performance Metrics:
The disclosed system may develop metrics that integrate athlete and equipment data (for example, the alignment between a player's hand and a basketball during release or the angle of a hockey stick blade during a slap shot).
3. Dynamic Equipment Modeling:
The disclosed system may allow for adaptable modeling of different equipment types, enabling evaluations across multiple sports contexts.
4. Feedback and Instruction Enhancements:
The disclosed system may provide real-time feedback that includes both the athlete and equipment (for example, suggesting grip adjustments or highlighting inconsistencies in equipment alignment).

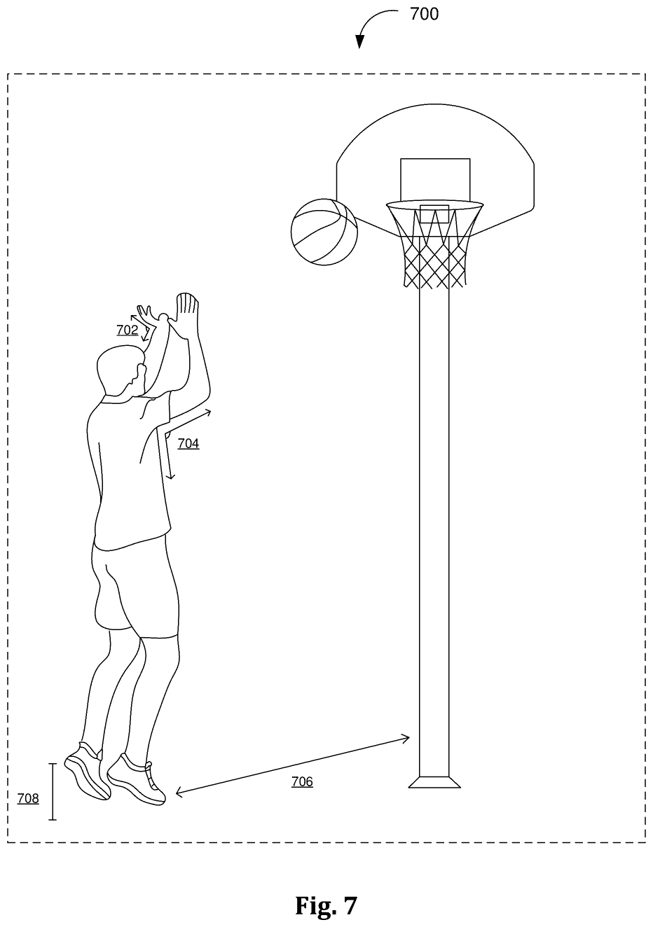

Further, in accordance with FIG. 7, the present disclosure illustrates a display device showing the integration of spatio-temporal data, wherein the spatio-temporal data comprises a wrist angle, a shot angle, a vertical distance of an athlete from the ground level, and a horizontal distance between the athlete and a post.

In some embodiments, the present disclosure may relate to a One-Touch AI Camera Calibration System. The system may streamline multi-camera calibration using an AI-powered, user-friendly approach. The system may dramatically reduce setup time and effort for multi-camera systems, allowing any operator to perform extrinsic calibration in seconds with minimal technical expertise. The system may be designed to scale from small to large setups (4-16 cameras) and support applications such as sports analytics, 3D reconstruction, and event monitoring.

Further, the existing camera calibration system may be designed to calibrate multiple cameras and rely on a lot of manual operations and complex steps. The complex steps are a time-consuming process, and the complex steps may increase the complexity and effort of the system. Further, the existing camera calibration system may demand technical expertise to perform the manual operations. Further, the complexity of the system may increase the risk of errors and affect the scalability of the system.

Further, the methods and system disclosed herein encompass the following key feature:
1. AI-Powered Object Segmentation:
   The methods and system may automatically detect and extract features of a selected object visible across multiple camera views.
2. One-Touch Extrinsic Calibration:
   Users tap on a common object in each camera view via a mobile or browser-based app.
   The method and system may compute 3D transformations and align cameras to a shared coordinate system.
3. Pre-Computed Intrinsic Calibration:
   Intrinsic parameters for known camera models are preloaded, eliminating repetitive calibration.
   The method and system may require an optional intrinsic calibration using a ChArUco Board or a similar function device for unknown or variable cameras.
4. Real-Time Feedback:
   The method and system may validate calibration accuracy and display alignment results instantly.
5. Scalability:
   The method and system may have been optimized for setups with 4-16 cameras, with potential for larger configurations.

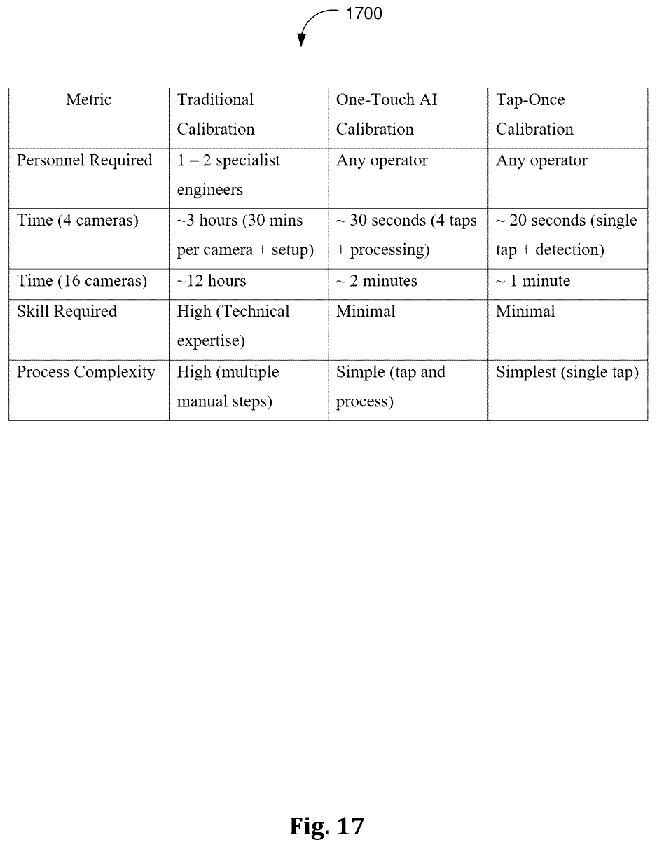

Further, the methods and system disclosed herein may be associated with the following technical details.
1. Architecture:
DeepStream Pipeline:
   The method and system may handle live video streams from multiple cameras.
   The method and system run AI segmentation models to identify and extract features of objects in each view.
Web-Based or Mobile App:
   The method and system may display synchronized camera feeds.
   The method and system may accept user taps on common objects to trigger segmentation and coordinate extraction.
Calibration Engine:
   The method and system may compute extrinsic parameters (rotation and translation matrices).
   The method and system may utilize pre-computed intrinsic parameters for known camera models.
Backend Services:
   The method and system may manage app-to-pipeline communication.
   The method and system may store intrinsic and extrinsic calibration data.
2. Functional Workflow:
User Interaction:
   The user taps on a common object visible across all camera feeds.
   The method and system may extract object features (e.g., contours, centers) automatically.
Feature Matching:
   The method and system may identify and match the object across all views to calculate transformations.
Calibration Completion:
   The method and system may compute transformation matrices and validate in real-time.
Time and Effort Savings:
   The time and effort savings are provided in the table 1700, as shown in FIG. 17.

Further, the present disclosure describes the following unique aspects of the One-Touch AI Calibration System:
1. User Interaction:
   Intuitive, user-driven interface allowing calibration via simple taps on objects visible across multiple camera views.
   Seamless integration with AI segmentation models to automate feature detection and matching.
2. AI Automation for Scalability:
   Applies to multi-camera setups (4-16 cameras) with minimal latency and high precision.
   The method and system eliminate the need for manual measurements or complex tools like calibration boards for extrinsic calibration.
3. Pre-Loaded Intrinsic Parameters:
   For known camera models, intrinsic calibration may be pre-computed and stored, avoiding repetitive intrinsic calibration processes.
4. Real-Time Calibration Feedback:
   The method and system may provide instant feedback on calibration accuracy, ensuring a streamlined and error-free process.

Further, the One-Touch AI Camera Calibration System may offer a transformative solution for multi-camera setups, combining AI-powered automation with an intuitive user interface.

Further, the present disclosure may encompass a simplified mode of the One-Touch AI Camera Calibration System. In the simplified mode, the user may hold a designated calibration object, ensuring that the holding side is the only visible instance of that object in all camera views. Instead of tapping in each view:
The system may automatically detect the object in all views using AI and computer vision.
The user may simply tap ‘Calibrate’ once, and the system handles both intrinsic and extrinsic calibration.

Further, the designated calibration object may include:
1. ChArUco Board or similar function device on a Paddle:
   A double-sided calibration board printed with a ChArUco pattern (checkerboard+AR markers) ensures that the double-sided calibration board may be easily detectable and provides precise feature points.
   The ChArUco may be mounted on a lightweight paddle so the user may hold the ChArUco above the user's head, making the ChArUco visible from multiple angles.
2. Common Object Option (e.g., Basketball):
   For scenarios where simplicity or lack of a paddle may be preferred, a basketball (or another predefined object) might serve as the calibration object.
   Limitations:
   Occlusion may occur (e.g., a back camera may not have a clear view).
   Less precise feature points compared to a ChArUco Board or similar function device.

Further, the disclosed method may encompass the following process:

Using the Charuco Paddle:
1. The user may hold the paddle above the user's head, ensuring that the paddle is visible from all cameras.
2. The user taps ‘Calibrate’ in the app or browser interface.
3. Behind the Scenes:
   Object Detection: The system may automatically detect the ChArUco Board or a similar function device in all camera views using feature recognition.
   Feature Extraction: The system may identify corners and AR markers on the board to compute coordinates.
   Extrinsic Calibration: The system may match the corresponding points across views, and the camera transformation matrices are calculated.
   Intrinsic Calibration (if needed): The board's pattern enables computation of intrinsic parameters if the camera model is unknown.
4. Calibration is completed, and real-time feedback may be displayed.

Using a Basketball or Similar Object:
1. The user holds the basketball and ensures that the basketball is visible in all views.
2. The user taps ‘Calibrate’ in the app.
3. Behind the Scenes:
   A segmentation model may detect the basketball in each view.
   The system computes extrinsic calibration based on the object's position in the camera views.

Further, the present disclosure describes the following advantages of using the ChArUco Paddle:
Occlusion Resilience:
Double-sided printing ensures that at least one side is visible to every camera.
The user may hold the calibration object high above the user's body, minimizing the chance of obstruction.
Precision:
The above method may provide highly accurate feature points for intrinsic and extrinsic calibration.
Ease of Use: A single tap (‘Calibrate’) makes the process intuitive and faster.

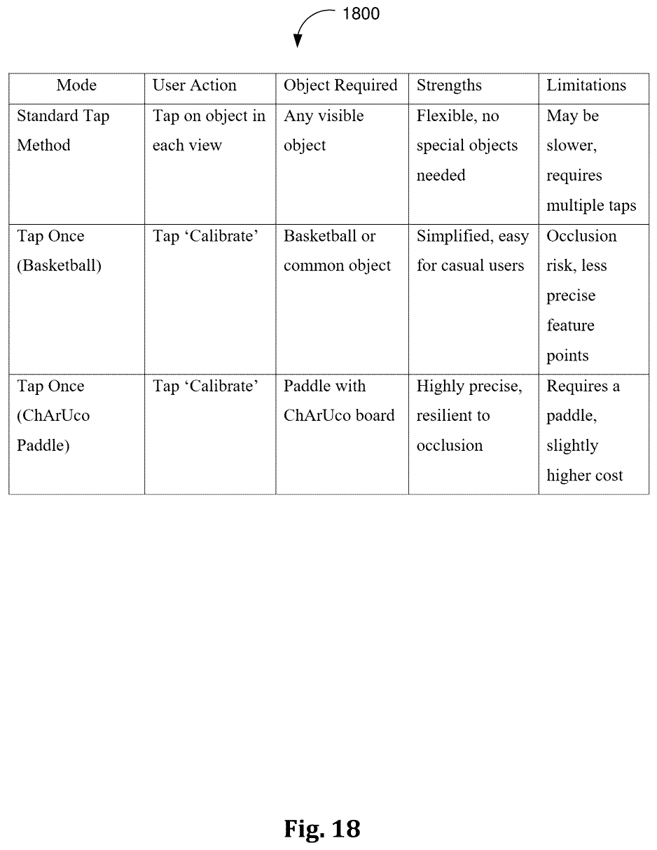

Further, the comparison of calibration modes as provided in the table 1800, as shown in FIG. 18.

Further, the addition of “Tap Once Calibration” mode, especially with a ChArUco paddle, further simplifies the calibration process and increases the system's robustness. The above approach may offer unmatched usability while maintaining precision, making the system a standout feature in both practical applications.

The present disclosure provides a method of facilitating real time sport performance evaluation based on spatial orientation. Further, the method may include receiving, using a communication device, motion orientation data associated with joint movement and body alignment from a client device. Further, the method may include determining, using a processing device, a rotational state based on the motion orientation data using a quaternion based orientation model. Further, the method may include generating, using the processing device, a performance metric based on the rotational state. Further, the method may include transmitting, using the communication device, the performance metric to the client device.

Further, in some embodiments, the method includes normalizing, using the processing device, the rotational state into a quaternion representation. Further, in some embodiments, the method includes constraining, using the processing device, the quaternion representation to maintain rotational continuity across successive computation cycle.

Further, in some embodiments, the method includes retrieving, using a storage device, a prior rotational state associated with an earlier time instance. Further, in some embodiments, the method includes computing, using the processing device, a rotational transition value based on a comparison between the prior rotational state and the rotational state.

Further, in some embodiments, the method includes transforming, using the processing device, the motion orientation data into a three dimensional reference frame. Further, in some embodiments, the method includes determining, using the processing device, a positional transition of a joint based on the transformed motion orientation data.

Further, in some embodiments, the method includes analyzing, using the processing device, a temporal sequence of the rotational state. Further, in some embodiments, the method includes identifying, using the processing device, a movement phase based on a change pattern detected within the temporal sequence.

Further, in some embodiments, the method includes applying, using the processing device, an adaptive scoring rule to the rotational state. Further, in some embodiments, the method includes adjusting, using the processing device, the performance metric based on an output of the adaptive scoring rule.

Further, in some embodiments, the method includes retrieving, using the storage device, a historical motion orientation data associated with an athlete. Further, in some embodiments, the method includes modifying, using the processing device, the performance metric based on a comparison between the historical motion orientation data and the motion orientation data.

Further, in some embodiments, the method includes analyzing, using the processing device, the rotational state to identify a motion pattern. Further, in some embodiments, the method includes classifying, using the processing device, a sport activity type associated with the motion pattern.

Further, in some embodiments, the method includes interpolating, using the processing device, the rotational state using a high precision quaternion interpolation technique. Further, in some embodiments, the method includes resolving, using the processing device, a micro level joint rotation based on the interpolated rotational state.

Further, in some embodiments, the method includes receiving, using the communication device, an equipment orientation data associated with a sport equipment. Further, in some embodiments, the method includes correlating, using the processing device, the equipment orientation data with the rotational state to refine the performance metric.

The present disclosure provides a system for facilitating real time sport performance evaluation based on spatial orientation. Further, the system may include a communication device. Further, the communication device may be configured for receiving motion orientation data associated with joint movement and body alignment from a client device. Further, the communication device may be configured for transmitting a performance metric to the client device. Further, the system may include a processing device. Further, the processing device may be configured for determining a rotational state based on the motion orientation data using a quaternion based orientation model. Further, the processing device may be configured for generating the performance metric based on the rotational state.

Further, in some embodiments, the processing device may be further configured for normalizing the rotational state into a quaternion representation. Further, the processing device may be further configured for constraining the quaternion representation to maintain rotational continuity across successive computation cycle.

In some embodiments, the system may further include a storage device which may be configured for storing a prior rotational state. Further, the processing device may be further configured for computing a rotational transition value based on a comparison between the prior rotational state and the rotational state.

Further, in some embodiments, the processing device may be further configured for transforming the motion orientation data into a three dimensional reference frame. Further, the processing device may be further configured for determining a positional transition of a joint based on the transformed motion orientation data.

Further, in some embodiments, the processing device may be further configured for analyzing a temporal sequence of the rotational state. Further, the processing device may be further configured for identifying a movement phase based on a change pattern detected within the temporal sequence.

Further, in some embodiments, the processing device may be further configured for applying an adaptive scoring rule to the rotational state. Further, the processing device may be further configured for adjusting the performance metric based on an output of the adaptive scoring rule.

In some embodiments, the system may further include a storage device which may be configured for storing a historical motion orientation data associated with an athlete. Further, the processing device may be further configured for modifying the performance metric based on a comparison between the historical motion orientation data and the motion orientation data.

Further, in some embodiments, the processing device may be further configured for analyzing the rotational state to identify a motion pattern. Further, the processing device may be further configured for classifying a sport activity type associated with the motion pattern.

Further, in some embodiments, the processing device may be further configured for interpolating the rotational state using a high precision quaternion interpolation technique. Further, the processing device may be further configured for resolving a micro level joint rotation based on the interpolated rotational state.

In some embodiments, the communication device may be further configured for receiving an equipment orientation data associated with a sport equipment. Further, the processing device may be further configured for correlating the equipment orientation data with the rotational state to refine the performance metric.

In some embodiments, the disclosed system may provide an inherent technical improvement to three dimensional orientation tracking technology by representing a joint rotational state using a quaternion based orientation model to address a technical problem of singularity and axis coupling that may occur in Euler angle representations, wherein the technical problem may manifest as gimbal lock or discontinuous angle wrap that degrades numerical stability and produces erroneous rotation estimates during rapid athletic motion, and wherein the quaternion based orientation model may be implemented by normalizing a four element quaternion at each update cycle to maintain a unit quaternion constraint, by computing an incremental quaternion from successive orientation samples and applying quaternion multiplication to propagate orientation, or by converting a measured axis-angle rotation into a quaternion and integrating the quaternion over time, and wherein example implementations may include computing a shoulder rotational state during a shot phase by maintaining quaternion continuity across successive frames, computing a wrist rotational state during a release phase by selecting a quaternion sign that minimizes discontinuity relative to a prior quaternion, or computing a hip rotational state during a directional shift by constraining quaternion drift through periodic renormalization, and wherein the improved technology may be a spatial

orientation estimation technology that may produce smoother rotational state trajectories and improved numerical robustness under high angular velocity.

In some embodiments, the disclosed system may provide an inherent technical improvement to spatio-temporal motion reconstruction technology by computing a rotational transition value between a prior rotational state and a current rotational state to address a technical problem of accurately quantifying rotation change across time under measurement noise and sampling jitter, and wherein the rotational transition value may be implemented by computing a relative quaternion as an inverse of the prior rotational state multiplied by the current rotational state, by converting the relative quaternion to an axis-angle representation to obtain a rotation magnitude and a rotation axis, or by computing a geodesic distance on a unit quaternion manifold to obtain a rotation distance that is invariant to parameterization, and wherein example implementations may include evaluating a rotation distance per time interval to estimate rotational velocity of a wrist, computing a cumulative transition across a phase window to estimate a phase rotation budget for a shoulder, or computing a transition outlier score to detect an anomalous rotational spike during a movement, and wherein the improved technology may be a rotational change computation technology that may enable more reliable phase-to-phase comparison and time aligned rotational analysis.

In some embodiments, the disclosed system may provide an inherent technical improvement to three dimensional kinematic analysis technology by determining a positional transition of a joint based on motion orientation data to address a technical problem of jointly analyzing rotation and translation in a coherent reference frame when movement is complex and multi-axis, and wherein the positional transition may be implemented by transforming orientation-tagged pose samples into a three dimensional reference frame, by associating a rotational state with a positional coordinate expressed in a common frame, or by computing a delta position between successive samples after applying a consistent reference frame transform, and wherein example implementations may include determining a vertical distance of an athlete from a ground level across a shot sequence, determining a horizontal distance between an athlete and a post across a drill, or determining a joint displacement correlated with a rotational transition during a release event, and wherein the improved technology may be a three dimensional motion quantification technology that may support combined rotational and positional evaluation without relying on a single axis projection.

In some embodiments, the disclosed system may provide an inherent technical improvement to automated movement segmentation technology by identifying a movement phase based on a change pattern in a temporal sequence of a rotational state to address a technical problem of reliably segmenting an athletic action into phase boundaries without requiring manual annotation, and wherein phase identification may be implemented by analyzing a temporal sequence of rotation distance values to detect a threshold crossing, by detecting a sustained change in rotational direction based on a sign change in an axis-angle component, or by detecting a characteristic pattern window such as a low-variance plateau followed by a high-variance burst associated with a transition from a pocket phase to a release phase, and wherein example implementations may include segmenting a shot into transfer, pocket, and release using a rotational state pattern of a shoulder, segmenting a throw preparation and throw execution using a rotational state pattern of a torso, or segmenting a goalie reposition and save event using a rotational state pattern of a hip and knee, and wherein the improved technology may be a phase segmentation technology that may reduce error from misaligned phase windows and may enable consistent cross-session comparison.

In some embodiments, the disclosed system may provide an inherent technical improvement to real time performance scoring technology by integrating an adaptive scoring rule with spatial orientation metric to address a technical problem of static scoring criteria that fail to generalize across athlete style, body morphology, or context variation, and wherein the adaptive scoring rule may be implemented by weighting a performance metric according to a learned mapping between rotational state features and a target performance outcome, by adjusting scoring parameter based on detected movement phase, or by updating a scoring threshold based on historical motion orientation data associated with an athlete, and wherein example implementations may include adjusting a release rotation tolerance for a basketball shot when a detected shot angle indicates a steeper trajectory, adjusting a body shift score during a football run when a directional change is detected, or adjusting a positioning score for a hockey goalie when lateral displacement is observed within a defensive zone window, and wherein the improved technology may be an adaptive evaluation technology that may deliver more stable and individualized scoring under varying movement conditions.

In some embodiments, the disclosed system may provide an inherent technical improvement to personalized feedback generation technology by modifying a performance metric based on historical motion orientation data associated with an athlete to address a technical problem of feedback volatility caused by short-term variation and to address a technical problem of generic feedback that does not reflect an athlete baseline, and wherein personalization may be implemented by storing historical motion orientation data and computing a baseline rotational state distribution for a movement phase, by computing a deviation score between a current rotational transition value and a historical distribution, or by computing a trend value across sessions to distinguish persistent mechanical drift from transient noise, and wherein example implementations may include generating a performance metric that reflects deviation of wrist rotation from an athlete baseline at a release phase, generating a performance metric that reflects improvement in shoulder alignment consistency across practice sessions, or generating a performance metric that reflects stability of torso rotation during a directional shift relative to historical variability, and wherein the improved technology may be a longitudinal performance analytics technology that may support athlete-specific calibration without requiring manual parameter tuning.

In some embodiments, the disclosed system may provide an inherent technical improvement to multi-sport motion analytics technology by applying a common quaternion based spatial orientation framework across sport activity type to address a technical problem of fragmented analytic pipelines that require sport-specific coordinate conventions and separate rotational representations, and wherein sport activity type classification may be implemented by analyzing the rotational state to identify a motion pattern signature, by mapping a motion pattern signature to a sport activity type label, or by selecting a phase segmentation profile based on an identified sport activity type, and wherein example implementations may include identifying a basketball shot pattern from a wrist rotational state sequence, identifying a football body shift pattern from a torso rotational state sequence, or identifying a hockey goalie positioning pattern from a hip rotational state sequence, and wherein the improved technology may be a reusable orientation analytics technology that may reduce re-engineering effort and may preserve consistent rotational semantics across different sport contexts.

In some embodiments, the disclosed system may provide an inherent technical improvement to high resolution joint rotation estimation technology by resolving a micro level joint rotation using high precision quaternion interpolation to address a technical problem of discretization error that occurs when sensor sampling rate or frame rate is insufficient to capture rapid micro-movement, and wherein high precision quaternion interpolation may be implemented by performing spherical linear interpolation between successive quaternion samples to reconstruct intermediate rotational states, by performing a normalized linear interpolation with renormalization when computational latency is constrained, or by selecting an interpolation interval adaptively based on a rotational transition magnitude, and wherein example implementations may include reconstructing intermediate wrist rotation during a short release interval to avoid underestimating peak rotation, reconstructing intermediate shoulder rotation during a high-acceleration phase to reduce aliasing, or reconstructing intermediate torso rotation during a pivot to align positional transition analysis with rotational state timing, and wherein the improved technology may be a temporal upsampling technology for orientation trajectories that may improve fidelity of derived rotational transition and scoring metrics.

In some embodiments, the disclosed system may provide an inherent technical improvement to athlete-and-equipment interaction analysis technology by correlating an equipment orientation data with a rotational state to address a technical problem of incomplete performance characterization when only biomechanical data is evaluated without the orientation of sport equipment, and wherein equipment orientation data integration may be implemented by receiving an equipment orientation data stream, by aligning the equipment orientation data stream with the motion orientation data using timestamp association, or by computing a composite performance metric that includes an alignment measure between an equipment orientation and a joint rotational state, and wherein example implementations may include computing an alignment measure between hand rotational state and ball orientation during a release, computing an alignment measure between stick orientation and body rotational state during a shot motion, or computing an alignment measure between bat orientation and torso rotational state during a swing motion, and wherein the improved technology may be a composite kinematic interaction technology that may produce more actionable feedback by including equipment alignment as a first class analytic variable.

In some embodiments, the disclosed system may provide an inherent technical improvement to spatio-temporal metric presentation technology by integrating multiple orientation-derived and position-derived values into a unified spatio-temporal data structure to address a technical problem of inconsistent metric synchronization across rotational and positional channels, and wherein the unified spatio-temporal data structure may be implemented by associating a wrist angle with a shot angle and with a vertical distance from a ground level and with a horizontal distance relative to a post using a common time index, by computing a synchronized sample record per update cycle, or by storing a time-aligned sequence of sample records for retrospective analysis, and wherein example implementations may include generating a per-frame record that includes wrist angle A, shot angle B, horizontal distance C, and vertical distance D for a shot sequence, generating a per-frame record that includes body shift rotation and field position offset for a run, or generating a per-frame record that includes goalie rotation and crease-relative offset for a positioning evaluation, and wherein the improved technology may be a time-aligned multi-channel data integration technology that may reduce correlation error between channels used for scoring and feedback.

In some embodiments, a technical improvement may be incorporated to enhance orientation tracking technology under heterogeneous sensor quality by performing uncertainty-aware filtering over the motion orientation data to address a technical problem of noisy or intermittently missing orientation samples that degrade quaternion continuity and downstream scoring, and wherein uncertainty-aware filtering may be implemented by associating a confidence value with each incoming motion orientation sample, by applying a filtering operation that weights quaternion updates based on the confidence value, or by selecting between

a predictive propagation and a measurement update based on confidence, and wherein example implementations may include applying a higher smoothing weight during low-confidence periods such as occlusion in a camera-based feed, applying a lower smoothing weight during high-confidence periods such as stable inertial measurement, or temporarily propagating a rotational state using a prior rotational transition value when an update is missing, and wherein the improved technology may be an orientation noise suppression technology that may improve robustness of real time tracking without changing the external interface of the SaaS.

In some embodiments, a technical improvement may be incorporated to enhance temporal alignment technology for multi-stream analytics by performing time synchronization between motion orientation data and equipment orientation data to address a technical problem of clock drift and inconsistent latency that produces false misalignment metrics, and wherein time synchronization may be implemented by estimating a latency offset between streams using a correlation of characteristic events such as peak rotational transition, by applying a time warp mapping to align sample indices, or by maintaining a server-side timebase and re-indexing samples upon receipt, and wherein example implementations may include aligning a hand rotation peak with a ball orientation change peak during a release, aligning a torso rotation peak with a stick blade angle change during a shot, or aligning a swing rotation peak with a bat orientation peak, and wherein the improved technology may be a multi-stream synchronization technology that may reduce systematic error in composite performance metric generation.

In some embodiments, a technical improvement may be incorporated to enhance adaptive scoring technology by enabling continuous model adaptation using federated parameter aggregation to address a technical problem of improving scoring generalization across athlete cohort while reducing exposure of raw motion orientation data, and wherein federated parameter aggregation may be implemented by generating a local scoring parameter update derived from historical motion orientation data associated with an athlete, by transmitting only the scoring parameter update rather than raw motion orientation data, or by aggregating scoring parameter updates across multiple athlete context partitions to update a shared adaptive scoring rule, and wherein example implementations may include updating a shared release-rotation tolerance parameter while retaining athlete-specific baselines on the server, updating a shared phase segmentation threshold based on aggregated transition statistics, or updating a shared motion pattern classifier parameter based on aggregated quaternion feature distributions, and wherein the improved technology may be an adaptive model update technology that may improve personalization scalability and privacy posture for a SaaS deployment.

In some embodiments, a technical improvement may be incorporated to enhance computational efficiency technology for real time SaaS inference by performing quaternion feature compression prior to scoring to address a technical problem of server-side throughput limitation when processing high-frequency motion orientation data, and wherein quaternion feature compression may be implemented by computing a reduced representation such as axis-angle magnitude and principal axis component from a quaternion, by computing a rotational transition summary over a time window rather than per-sample processing, or by quantizing quaternion-derived features while maintaining an error bound acceptable for scoring, and wherein example implementations may include compressing wrist rotation features into a per-phase summary for shot evaluation, compressing torso rotation features into a per-transition profile for body shift evaluation, or compressing goalie rotation features into a per-positioning segment descriptor, and wherein the improved technology may be a real time analytics throughput technology that may enable lower latency scoring under high concurrency.

In some embodiments, a technical improvement may be incorporated to enhance explainable feedback technology by generating an intermediate diagnostic metric that decomposes the performance metric into phase-specific contribution to address a technical problem of opaque aggregate scoring that provides limited actionable insight, and wherein phase-specific contribution may be implemented by generating a separate metric per movement phase based on rotational transition value within the phase, by generating a deviation metric relative to historical motion orientation data per phase, or by generating an alignment metric between equipment orientation data and rotational state per phase, and wherein example implementations may include generating a transfer contribution, a pocket contribution, and a release contribution for a shot score, generating a wind-up contribution and a throw contribution for a throw score, or generating a lateral-shift contribution and a set-position contribution for a goalie score, and wherein the improved technology may be a diagnostic metric generation technology that may improve interpretability while retaining the core quaternion-based tracking pipeline.

In some embodiments, a technical improvement may be incorporated to enhance data integrity technology for streamed motion analytics by performing consistency verification on received motion orientation data to address a technical problem of malformed or physically implausible orientation sequences that corrupt rotational state computation, and wherein consistency verification may be implemented by verifying a unit quaternion constraint within a tolerance, by verifying that a rotational transition value does not exceed a physically plausible bound for a given time interval, or by verifying that a sign selection for quaternion continuity yields a minimized discontinuity relative to a prior rotational state, and wherein example implementations may include rejecting a motion orientation sample that fails normalization constraints, flagging a transition spike as a probable sensor glitch and substituting an interpolated rotational state, or gating scoring updates until a verified continuity condition is restored, and wherein the improved technology may be a streaming data validation technology that may increase reliability of SaaS outputs under diverse client capture pipelines.

The present disclosure provides a method of facilitating extrinsic camera calibration. Further, the method may include receiving, using a communication device, image data associated with a common object from a camera system. Further, the method may include receiving, using the communication device, interaction data representing a single user interaction associated with the common object from a client device. Further, the method may include identifying, using a processing device, an object feature in the image data based on the interaction data. Further, the method may include computing, using the processing device, an extrinsic calibration data based on the object feature. Further, the method may include storing, using a storage device, the extrinsic calibration data. Further, the method may include transmitting, using the communication device, the extrinsic calibration data to the client device.

Further, in some embodiments, the method includes analyzing, using the processing device, the image data to generate a segmentation mask corresponding to the common object. Further, in some embodiments, the method includes extracting, using the processing device, a geometric representation of the object feature from the segmentation mask.

Further, in some embodiments, the method includes associating, using the processing device, the object feature with a spatial reference in each camera view represented in the image data. Further, in some embodiments, the method includes correlating, using the processing device, the spatial reference across the camera view to establish object correspondence.

Further, in some embodiments, the method includes identifying, using the processing device, a camera model identifier associated with the image data. Further, in some embodiments, the method includes retrieving, using the storage device, an intrinsic parameter corresponding to the camera model identifier.

Further, in some embodiments, the method includes detecting, using the processing device, an absence of a stored intrinsic parameter associated with the image data. Further, in some embodiments, the method may include deriving, using the processing device, an intrinsic parameter from the object feature.

Further, in some embodiments, the method includes evaluating, using the processing device, a reprojection consistency associated with the extrinsic calibration data. Further, in some embodiments, the method may include determining, using the processing device, a calibration accuracy metric based on the reprojection consistency.

Further, in some embodiments, the computing the extrinsic calibration data may include aggregating, using the processing device, the object feature from a scalable camera configuration. Further, the computing the extrinsic calibration data may include solving, using the processing device, a transformation model that may align the scalable camera configuration to a shared coordinate system.

Further, in some embodiments, the identifying the object feature may include automatically selecting, using the processing device, a feature extraction strategy based on the image data. Further, the identifying the object feature may include executing, using the processing device, the feature extraction strategy without requiring a user-defined calibration parameter.

Further, in some embodiments, the computing the extrinsic calibration data may include executing, using the processing device, a reduced-complexity optimization routine. Further, the computing the extrinsic calibration data may include terminating, using the processing device, the optimization may be routine upon satisfaction of a convergence threshold.

Further, in some embodiments, the method includes indexing, using the storage device, the extrinsic calibration data with a session identifier. Further, in some embodiments, the method may include retrieving, using the storage device, the extrinsic calibration data for reuse in a subsequent calibration operation.

The present disclosure provides a system for facilitating extrinsic camera calibration. Further, the system may include a communication device. Further, the communication device may be configured for receiving image data associated with a common object from a camera system. Further, the communication device may be configured for receiving interaction data representing a single user interaction associated with the common object from a client device. Further, the communication device may be configured for transmitting extrinsic calibration data to the client device. Further, the system may include a processing device. Further, the processing device may be configured for identifying an object feature in the image data based on the interaction data. Further, the processing device may be configured for computing the extrinsic calibration data based on the object feature. Further, the system may include a storage device which may be configured for storing the extrinsic calibration data.

Further, in some embodiments, the processing device may be further configured for analyzing the image data to generate a segmentation mask corresponding to the common object. Further, the processing device may be further configured for extracting a geometric representation of the object feature from the segmentation mask.

Further, in some embodiments, the processing device may be further configured for associating the object feature with a spatial reference in each camera view represented in the image data. Further, the processing device may be further configured for correlating the spatial reference across the camera view to establish object correspondence.

In some embodiments, the processing device may be further configured for identifying a camera model identifier associated with the image data. Further, the storage device may be further configured for retrieving an intrinsic parameter corresponding to the camera model identifier.

In some embodiments, the processing device may be further configured for detecting an absence of a stored intrinsic parameter associated with the image data; deriving an intrinsic parameter from the object feature. Further, the storage device may be further configured for storing the intrinsic parameter.

Further, in some embodiments, the processing device may be further configured for evaluating a reprojection consistency associated with the extrinsic calibration data. Further, the processing device may be further configured for determining a calibration accuracy metric based on the reprojection consistency.

Further, in some embodiments, the processing device may be further configured for aggregating the object feature from a scalable camera configuration. Further, the processing device may be further configured for solving a transformation model that may align the scalable camera configuration to a shared coordinate system.

Further, in some embodiments, the processing device may be further configured for automatically selecting a feature extraction strategy based on the image data. Further, the processing device may be further configured for executing the feature extraction strategy without requiring a user-defined calibration parameter.

Further, in some embodiments, the processing device may be further configured for executing a reduced-complexity optimization routine for computing the extrinsic calibration data. Further, the processing device may be further configured for terminating the reduced-complexity optimization routine upon satisfaction of a convergence threshold.

Further, in some embodiments, the storage device may be further configured for indexing the extrinsic calibration data with a session identifier. Further, the storage device may be further configured for retrieving the extrinsic calibration data for reuse in a subsequent calibration operation.

In some embodiments, the disclosed system may provide inherent technical improvements in the field of multi-camera calibration technology, particularly in relation to extrinsic camera calibration for distributed camera systems. A technical problem in conventional multi-camera calibration systems is that extrinsic calibration typically requires specialized calibration patterns, manual measurements, or expert intervention, which increases system setup time and introduces human-induced error. In some embodiments, the given technical problem may be addressed by enabling AI-based detection of a common object across multiple camera views, wherein the system may perform feature extraction and correspondence determination automatically using learned segmentation models. Such segmentation models may be implemented using convolutional neural networks, transformer-based vision models, or hybrid architectures that are trained to isolate object contours, centroids, or keypoints under varying lighting and occlusion conditions. As a result, the technology of computer vision-based camera calibration may be improved by reducing dependence on rigid calibration artifacts and by increasing robustness in uncontrolled environments.

In some embodiments, the disclosed system may further improve the technology of geometric camera alignment by enabling extrinsic calibration to be computed from sparse object-derived features rather than dense calibration grids. A technical problem addressed in the given context is that traditional calibration methods rely on a large number of precisely located fiducial points, which may not be consistently visible across all camera views. In some embodiments, the system may compute transformation matrices by deriving relative spatial relationships between object features detected in each camera view, where such relationships may be expressed as reprojection constraints, epipolar consistency measures, or pose hypotheses that are refined iteratively. The processing device may implement optimization routines that converge using fewer observations, thereby improving computational efficiency while maintaining accuracy, improving the technology of 3D spatial reconstruction and alignment by enabling reliable calibration with minimal visual information.

In some embodiments, the disclosed system may inherently improve human-computer interaction technology in calibration workflows by reducing complex multi-step procedures into a single user interaction. A technical problem in existing systems is that calibration workflows often require repeated user input, such as selecting multiple points, adjusting parameters, or repositioning calibration targets. In some embodiments, the system may interpret a single interaction signal as a calibration trigger and may automatically infer all necessary calibration context from previously received image data. The given aspect may be implemented by synchronizing user interaction data with buffered video streams and triggering segmentation and calibration pipelines without further user involvement. As a result, the technology of interactive system configuration may be improved by minimizing cognitive and operational load on the user.

In some embodiments, the disclosed system may inherently improve scalable multi-camera system technology by enabling calibration across variable camera counts without modifying the calibration workflow. A technical problem in scalable camera deployments is that adding or removing cameras often requires recalibration of the entire system using specialized procedures. In some embodiments, the processing device may aggregate object features detected from a scalable camera configuration and may solve transformation relationships relative to a shared coordinate system, regardless of the number of cameras involved. The given aspect may be implemented using graph-based optimization techniques or centralized pose estimation models that accommodate variable node counts. Consequently, the technology of distributed sensing systems may be improved by supporting elastic system scaling with minimal reconfiguration effort.

In some embodiments, the disclosed system may inherently improve real-time calibration validation technology by enabling immediate assessment of calibration quality. A technical problem in conventional systems is that calibration errors are often detected only after deployment, leading to costly rework. In some embodiments, the processing device may compute reprojection error metrics, alignment residuals, or consistency scores immediately after calibration and may generate accuracy indicators based on predefined thresholds or learned quality models. Such validation may be performed continuously as additional data is received, thereby improving the technology of real-time system verification.

In some embodiments, the disclosed system may inherently improve cloud-based calibration-as-a-service technology by centralizing calibration computation and data management within an online server environment. A technical problem in edge-based calibration approaches is limited computational capability and inconsistent calibration state management across devices. In some embodiments, the storage device may persist intrinsic and extrinsic calibration data indexed by session identifiers, camera identifiers, or deployment contexts, enabling reuse and consistency across sessions, improving the technology of software-as-a-service deployment for computer vision systems by enabling stateless client devices and centralized intelligence.

In some embodiments, the disclosed system may further include technical improvements that enhance specific technologies used in the system. In some embodiments, a technical problem of calibration instability under partial occlusion may be addressed by implementing adaptive feature confidence weighting. The processing device may assign confidence scores to detected object features based on visibility, segmentation certainty, or temporal stability, and may weight such features during transformation computation, improving the technology of robust pose estimation under real-world conditions.

In some embodiments, a technical problem of latency in multi-camera calibration may be addressed by incorporating asynchronous stream alignment techniques. The processing device may temporally align image data received from different cameras by estimating capture offsets using motion correlation or object trajectory analysis, thereby enabling calibration without requiring strict hardware synchronization, improving the technology of time-aware computer vision processing.

In some embodiments, a technical problem of model generalization across diverse environments may be addressed by enabling dynamic model selection or adaptation. The processing device may select or fine-tune segmentation models based on scene characteristics inferred from the image data, such as lighting conditions, background complexity, or object scale, improving the technology of adaptive AI inference systems in calibration applications.

In some embodiments, a technical problem of redundant computation across calibration sessions may be addressed by implementing incremental calibration refinement. The storage device may store historical calibration data, and the processing device may refine existing extrinsic calibration data using newly received object feature observations rather than recomputing calibration from scratch, improving the technology of incremental optimization systems.

In some embodiments, a technical problem of interoperability across heterogeneous camera models may be addressed by implementing a normalized intrinsic parameter abstraction layer. The processing device may transform camera-specific intrinsic parameters into a unified representation used internally for calibration computation, thereby decoupling calibration logic from camera hardware diversity, improving the technology of hardware-agnostic camera calibration frameworks.

Further, the present disclosure describes a method for provisioning a spatio-temporal feedback based on an activity.

Further, in some embodiments, the method may include obtaining, using the processing device, at least one output using at least one large language model based on at least one input and at least one instruction. Further, the at least one large language model may comprise a transformer-based autoregressive sequence generation model including a plurality of transformer decoder layers configured to generate an output token sequence conditioned on an input context.

Further, in some embodiments, the at least one input may include (i) the activity data and/or the spatial characteristic data determined based on analyzing the activity data using the spatial orientation model, (ii) at least one time-window identifier associated with performance of the activity, and (iii) at least one device characteristic corresponding to at least one of a capability, limitation, operation, and state of the user device. Further, the at least one device characteristic may be obtained from an operating system API of the user device, a network stack measurement routine, a device capability profile stored in memory, or a telemetry message transmitted from the user device to the processing device.

Further, in some embodiments, the at least one instruction may specify at least (i) a required machine-readable output format for a spatio-temporal feedback instruction set and (ii) at least one constraint derived from at least one dynamic user characteristic. Further, the at least one constraint may include a maximum allowed joint-angle correction per time window, a maximum haptic intensity level, a maximum feedback update frequency, a minimum confidence threshold before issuing real-time corrective actions, or a requirement to generate feedback in a selected modality that the user device supports.

Further, in some embodiments, the obtaining of the at least one output may include determining, using the processing device, at least one value for at least one model parameter associated with the at least one large language model based on the at least one instruction and/or at least one dynamic user characteristic. Further, the at least one model parameter may govern inference behavior and may include a maximum output token budget, a context-window length, a decoding parameter (including temperature, top-k sampling, top-p sampling, beam size, or repetition penalty), and/or an execution parameter including numerical precision or quantization bit-width for executing model weights.

Further, in some embodiments, the obtaining of the at least one output may include selecting, using the processing device, an execution configuration to satisfy a target resource constraint. Further, the execution configuration may include selecting between (i) a first precision configuration and (ii) a second reduced-precision configuration, selecting between local execution and edge execution, and/or selecting a model variant having a reduced parameter count. Further, the target resource constraint may include a target end-to-end latency, a memory ceiling, and/or a maximum network payload size for each incremental update.

Further, in some embodiments, the method may include inputting the at least one input to the at least one large language model based on the determining and/or the selecting. Further, “inputting” may include constructing a composite model context comprising an instruction portion and an input portion, encoding the composite model context into model-consumable inputs, and providing the model-consumable inputs to the transformer-based autoregressive sequence generation model for inference.

Further, in some embodiments, inputting the at least one input and the at least one instruction to the at least one large language model may include the following steps:
1. Further, the processing device may serialize at least a portion of the spatial characteristic data for the time-window identifier into a structured representation, including time-indexed feature values (e.g., orientation quaternion values, joint angle values, deviation metrics, and associated confidence values).
2. Further, the processing device may construct an instruction payload specifying an output schema and constraints, including at least one of a maximum number of control primitives per time window, a permitted modality set determined from device characteristics, and a maximum payload size per update.
3. Further, the processing device may combine the instruction payload with the structured representation and the user query to generate a composite model context.
4. Further, the processing device may encode the composite model context into model-consumable inputs by tokenizing text portions into token identifiers and converting numeric portions into a canonical text form or a numeric embedding representation.
5. Further, the processing device may provide the token identifiers and/or embeddings to the transformer-based autoregressive sequence generation model along with inference configuration values corresponding to the determined model parameters.
6. Further, the transformer-based autoregressive sequence generation model may generate a structured output token sequence, which is decoded into the machine-readable spatio-temporal feedback instruction set.

Further, in some embodiments, the at least one output may include a machine-readable spatio-temporal feedback instruction set that specifies time-indexed feedback actions executable by the user device. Further, the machine-readable instruction set may include a plurality of time-indexed control primitives, and each control primitive may include fields including (i) a time offset, (ii) a modality identifier, (iii) an action type identifier, and (iv) one or more action parameters.

Further, in some embodiments, the action parameters may include a corrective rotation vector, a corrective translation vector, a target pose parameter, a haptic waveform identifier, a haptic intensity, an audio prompt identifier, or a visual overlay identifier. Further, the corrective rotation vector may be represented as Euler deltas or quaternion deltas (e.g., Δq) depending on the selected schema.

Further, in some embodiments, the method may include validating, using the processing device, the machine-readable spatio-temporal feedback instruction set prior to transmitting the feedback data. Further, validating may include checking that required fields are present, checking type conformance, checking bounds on numeric values, and verifying that time offsets fall within the referenced time window.

Further, in some embodiments, in response to detecting that at least one control primitive violates the schema, the processing device may correct the control primitive, remove the control primitive, or re-invoke inference with additional constraints. Further, schema validation enables deterministic parsing and execution on the user device and reduces failure modes caused by malformed outputs.

Further, in some embodiments, the method may include selecting a numerical precision or quantization bit-width for executing model weights based on the device characteristic. Further, the method may execute the model using at least one of 16-bit, 8-bit, 4-bit, or mixed-precision inference to satisfy memory and latency constraints.

Further, in some embodiments, the method may include selecting between a first model variant and a second compressed model variant. Further, the second compressed model variant may be produced using quantization, pruning, knowledge distillation, or low-rank adaptation. Further, selecting among model variants and precision configurations reduces memory footprint and improves inference latency, thereby improving computing performance for real-time feedback generation.

Further, in some embodiments, the method may include selecting between local execution and edge execution based on measured network characteristics and device state. Further, the processing device may measure network latency and bandwidth using round-trip time measurements, transport-layer statistics, or application-layer telemetry. Further, in response to determining that local compute is insufficient or that latency targets cannot be satisfied locally, the method may route inference to an edge compute node within a threshold network distance of the user device, thereby reducing end-to-end delay.

Further, in some embodiments, the method may include transmitting the feedback data as a sequence of incremental updates, each incremental update corresponding to a time window and including a sequence identifier and time offset. Further, the user device may maintain a jitter buffer to reorder out-of-order updates and to smooth variable arrival times.

Further, in some embodiments, the method may include dynamically adjusting jitter buffer depth based on measured latency variation. Further, adjusting the jitter buffer depth may include increasing the buffer depth when network jitter increases and reducing the buffer depth when network jitter decreases, thereby maintaining a target end-to-end feedback delay while reducing dropped or late feedback updates.

Further, in some embodiments, the method may include applying forward error correction or redundant packetization to incremental updates based on measured packet loss rate, thereby improving continuity of spatio-temporal feedback actions under adverse network conditions.

Further, in some embodiments, the method may include computing a confidence score associated with the spatial characteristic data based on sensor noise metrics, occlusion detection, and/or residual error of the spatial orientation model. Further, the confidence score may be computed per time window or per feature.

Further, in some embodiments, the method may select a feedback modality, intensity, or update rate based on the confidence score. For example, when confidence is below a threshold, the method may reduce update frequency, switch from real-time haptics to summary visual guidance, or increase smoothing of corrective actions. This reduces erroneous or unstable feedback outputs caused by low-quality sensor estimates.

Further, in some embodiments, the method may include enforcing device constraints prior to transmitting or executing the machine-readable instruction set. Further, enforcing may include verifying that haptic intensity does not exceed a maximum supported by the device, that audio amplitude does not exceed a maximum level, that visual overlay density does not exceed a rendering threshold, and that update rate does not exceed a maximum supported frame rate. Further, in response to a violation, the method may clamp values, remove control primitives, or re-generate the instruction set under stricter constraints.

Further, in some embodiments, the disclosed operations are performed by a processing device executing instructions stored in non-transitory memory and by a communication device and storage device, as recited in the claims. Further, the disclosure describes specific algorithmic steps (serialization, encoding, schema validation, quantization selection, jitter buffering, etc.). Further, the disclosure avoids purely functional “means for” claiming by tying the functions to specific computing structures (processor, memory, tokenizer/encoder, transformer inference engine, schema validator, network measurement routines, jitter buffer routines).

Further, the dynamic user characteristic value is treated as input data, and the instruction is a directive that uses that value to set constraints. The instruction may specify constraints computed from the dynamic user characteristic (e.g., a fatigue value causes reduction of feedback intensity).

Further, in some embodiments, “activity data” may refer to digital data representing performance of an activity by a user and may include time-stamped samples from one or more sensors, including inertial measurement unit (IMU) data (e.g., accelerometer, gyroscope, magnetometer), camera-derived pose or keypoints, depth sensor data, pressure/force sensor data, wearable sensor data, or combinations thereof. Further, the activity data may include sensor metadata such as sampling rate, sensor calibration parameters, and sensor confidence indicators.

Further, in some embodiments, “spatial orientation model” may refer to a computational model executed by the processing device to estimate orientation or pose of an object (including the user) over time. Further, the spatial orientation model may include a quaternion model, a sensor-fusion model, and/or a learned pose estimator.

Further, in some embodiments, “spatial characteristic data” may refer to computed values derived from the activity data and the spatial orientation model and may include, for one or more time windows, joint angles, angular velocities, pose vectors, segment orientation quaternions, trajectory deviation metrics, stability metrics, or posture deviation metrics. Further, spatial characteristic data may include a confidence score for each computed value.

Further, in some embodiments, a “time-window identifier” may refer to a value identifying a temporal segment of the activity. Further, the time-window identifier may include a time interval [t_start, t_end], a frame index range, a sample index range, an epoch timestamp bucket, or a repetition number and sub-phase identifier.

Further, in some embodiments, a “device characteristic” may refer to a value describing a capability, limitation, operation, or state of the user device. Further, the device characteristic may include available memory, processor type (e.g., CPU/GPU/NPU), current CPU/GPU load, battery level, thermal state, network type, measured bandwidth, measured latency, packet loss rate, display resolution, frame rate, availability of haptics, availability of audio output, or sensor availability state.

Further, in some embodiments, a “dynamic user characteristic” may refer to a user-associated value that changes over time or over sessions. Further, the dynamic user characteristic may include a fatigue indicator, a responsiveness metric to prior feedback, a range-of-motion constraint observed during the activity, a movement variability metric, a tremor metric, a discomfort indicator provided by the user, a safety risk score computed from deviation patterns, or a confidence score associated with the spatial characteristic data.

Further, in some embodiments, an “instruction” may refer to a machine-executable or machine-interpretable directive that constrains how the language model generates outputs. Further, the instruction may specify an output format (e.g., schema), a target modality, a safety constraint, a timing constraint, a maximum payload size, or a target end-to-end latency. Further, an instruction is distinct from an “input” in that the instruction governs generation behavior, while the input supplies data used to generate a result.

Further, in some embodiments, an “input” may refer to the data provided to the language model for inference, including the activity data and/or spatial characteristic data, the time-window identifier, the user query, and device characteristics.

Further, in some embodiments, a “machine-readable spatio-temporal feedback instruction set” may refer to a structured data object that is parseable and executable by software on the user device. Further, the machine-readable spatio-temporal feedback instruction set may be represented as a JSON object, a protocol buffer (protobuf) message, a CBOR payload, an XML message, or another structured format, and may include time-indexed control primitives.

Further, in some embodiments, a “control primitive” may refer to a structured instruction specifying a feedback action at a time or time offset, including a corrective rotation vector, corrective translation vector, pose target, haptic event, audio event, or visual overlay event.

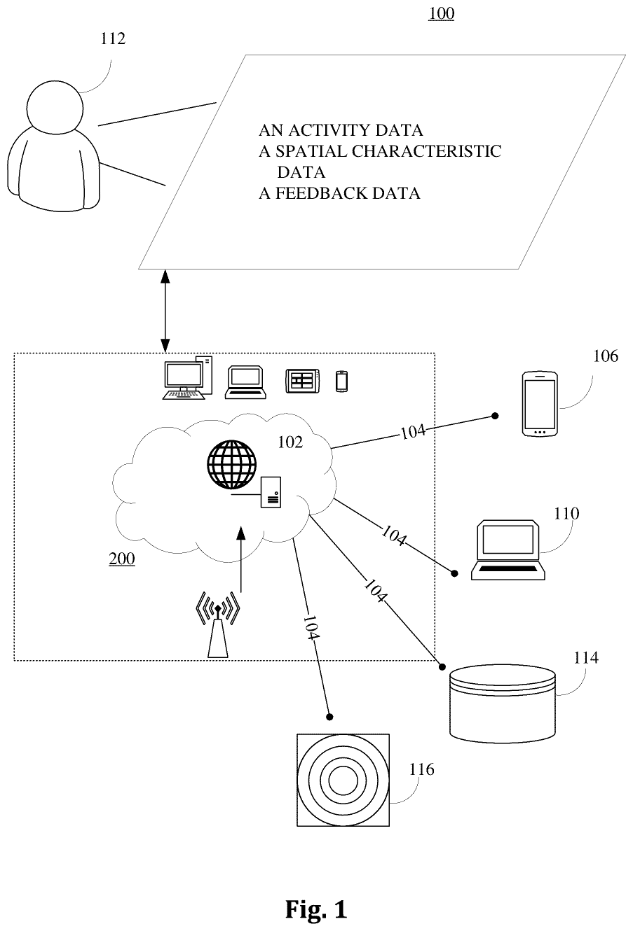

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

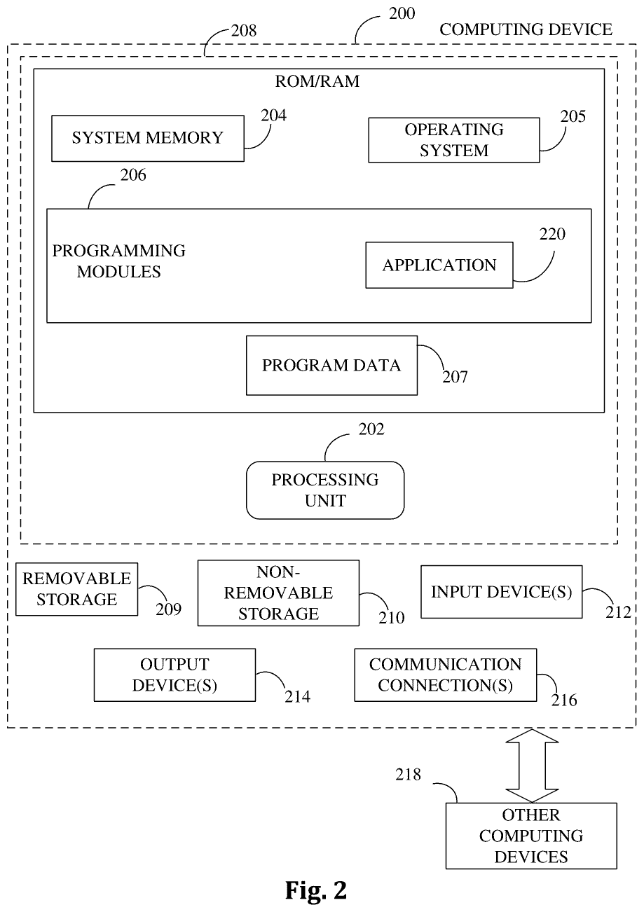

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

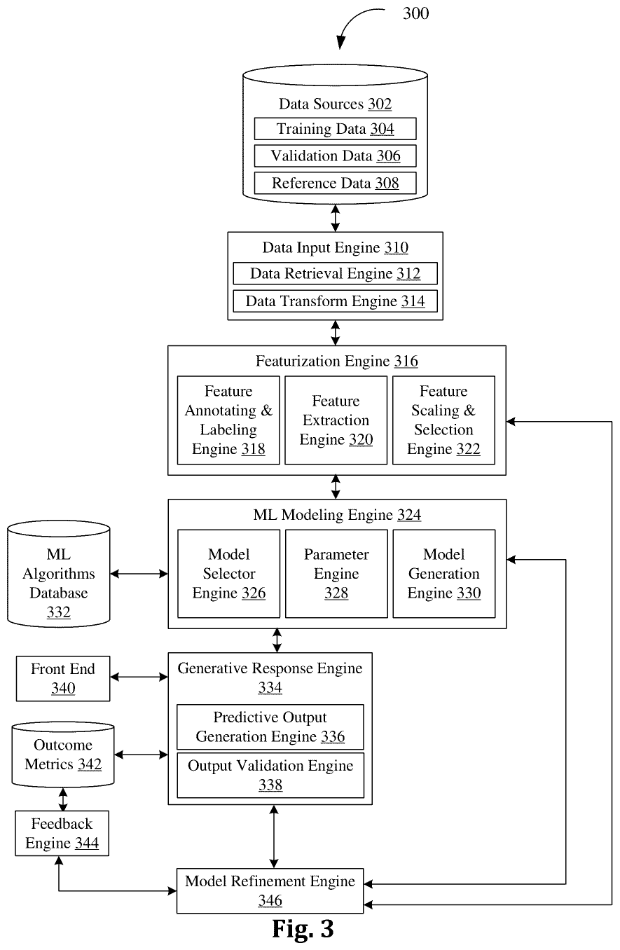

FIG. 3 is a block diagram illustrating a machine-learning system 300 for implementing various embodiments of this disclosure, in accordance with some embodiments. Although the disclosed machine-learning system 300 depicts particular system components and an arrangement of such components, the given depiction is to facilitate a discussion of the present technology and should not be considered limiting unless specified in the appended claims. For, example some components that are illustrated as separate, may be combined with other components and some components may be divided into separate components.

Accordingly, the machine-learning system 300 may include a plurality of interrelated modules and engines configured to implement a machine-learning pipeline. Further, the machine-learning system 300 may include a data sources module 302 that is made up of a training data repository 304, a validation data repository 306, and a reference data repository 308, each repository being configured to store respective classes of input records and reference information. Further, the machine-learning system 300 may include a data input engine 310 configured to receive data from the data sources module 302. Further, the data input engine 310 may include a data retrieval engine 312 configured to access and ingest data from the repositories (304, 306, 308), and a data transform engine 314 configured to perform initial normalization, parsing and format conversion on the ingested data. Further, the machine-learning system 300 may include a featurization engine 316 configured to prepare temporal and predictive representations of transformed data. Further, the featurization engine 316 may include a feature annotating & labeling engine 318 for applying labels and annotations to data instances, a feature extraction engine 320 for deriving feature vectors and candidate predictors, and a feature scaling & selection engine 322 for performing numerical scaling, dimensionality reduction and selection of salient features. Further, the machine-learning system 300 may include a machine learning (ML) modeling engine 324 configured to construct predictive models from selected features. Further, the ML modeling engine 324 may include a model selector engine 326 for selecting among candidate model classes, a parameter engine 328 for determining and tuning hyper parameters, and a model generation engine 330 for instantiating and training model artifacts according to selected architectures and parameters. Further, the machine-learning system 300 may include an ML algorithms database 332 configured to store algorithmic implementations, model templates and associated metadata and to be accessible by components of the ML modeling engine 324. Further, the machine-learning system 300 may include a generative response engine 334 configured to produce user-facing outputs based on the trained models. Further, the generative response engine 334 may include a predictive output generation engine 336 for generating predictions or synthesized responses and an output validation engine 338 for verifying, filtering and validating generated outputs against predefined criteria and reference data. Further, the machine-learning system 300 may include a front end 340 configured to present validated outputs to end users and to collect interaction signals. Further, the machine-learning system 300 may include an outcome metrics module 342 configured to compute performance measures, accuracy statistics and other evaluation metrics derived from model outputs and user interactions. Further, the machine-learning system 300 may include a feedback engine 344 configured to aggregate outcome metrics and user feedback and to format such information for reuse. Further, the machine-learning system 300 may include a model refinement engine 346 configured to receive feedback from the feedback engine 344 and the outcome metrics module 342, and to effect iterative updates to the ML modeling engine 324 and to the ML algorithms database 332. Further, the components are communicatively coupled so that data and control signals are exchanged among the repositories (304, 306, 308), the data input engine 310, the featurization engine 316, the ML modeling engine 324 (with algorithmic support from the ML algorithms database 332), the generative response engine 334 and the front end 340 for output generation. Further, the outcome metrics 342 and feedback engine 344 provide closed-loop signals to the model refinement engine 346 to enable retraining, parameter adjustment and algorithm selection, thereby enabling cooperative execution of data acquisition, feature engineering, model construction, output generation, validation, evaluation and iterative refinement within the disclosed machine-learning system 300.

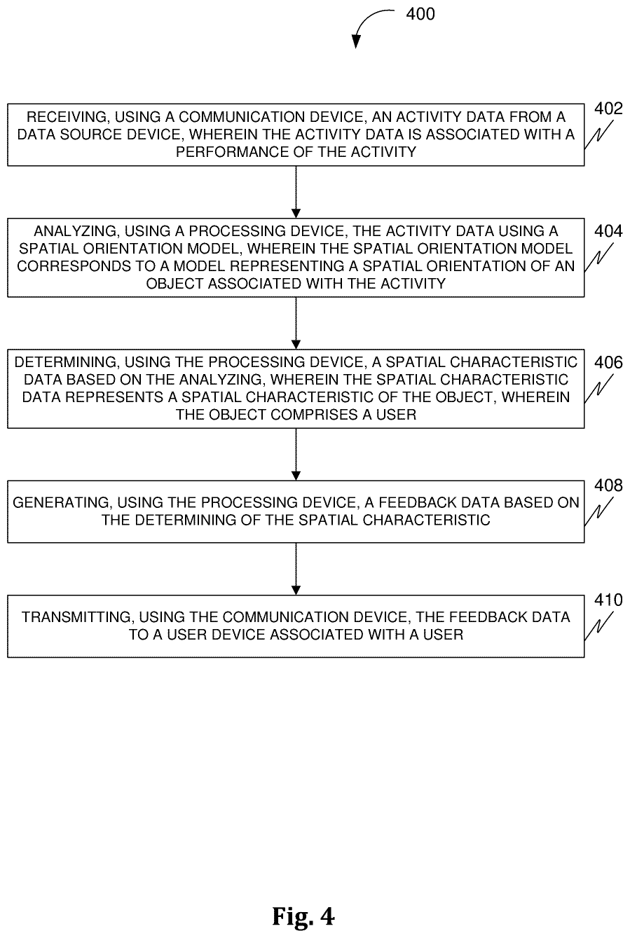

FIG. 4 illustrates a flowchart of a method 400 for provisioning a spatio-temporal feedback based on an activity, in accordance with some embodiments. Accordingly, the method 400 may include a step 402 of receiving, using a communication device 602, an activity data from a data source device 608. Further, the activity data may be associated with a performance of the activity. Further, the method 400 may include a step 404 of analyzing, using a processing device 604, the activity data using a spatial orientation model. Further, the spatial orientation model corresponds to a model representing a spatial orientation of an object associated with the activity. Further, the method 400 may include a step 406 of determining, using the processing device 604, a spatial characteristic data based on the analyzing. Further, the spatial characteristic data represent a spatial characteristic of the object. Further, the object includes a user. Further, the method 400 may include a step 408 of generating, using the processing device 604, a feedback data based on the determining of the spatial characteristic. Further, the method 400 may include a step 410 of transmitting, using the communication device 602, the feedback data to a user device 610 associated with a user.

In some embodiments, the spatial orientation model includes one or more of a quaternion model and a three-dimensional mathematical model.

In some embodiments, the activity may be associated with two or more objects. Further, the feedback data includes an object data corresponding to the object. Further, the object further includes a sport equipment.

In some embodiments, the activity data includes two or more activity data corresponding to two or more activity phases. Further, the two or more activity phases include a first activity phase associated with a first time period and a second activity phase associated with a second time period. Further, the second time period occurs later than the first time period. Further, the generating of the feedback data includes generating a transition data based on each of the first activity phase and the second activity phase. Further, the transition data represent a transition from the first activity phase to the second activity phase.

In some embodiments, the method 400 may further include computing, using the processing device 604, a transition metric based on the transition data. Further, the transition metric corresponds to the transition associated with the performance of the activity. Further, the transition includes one or more of a rotational transition and a positional transition of the object relative to the activity.

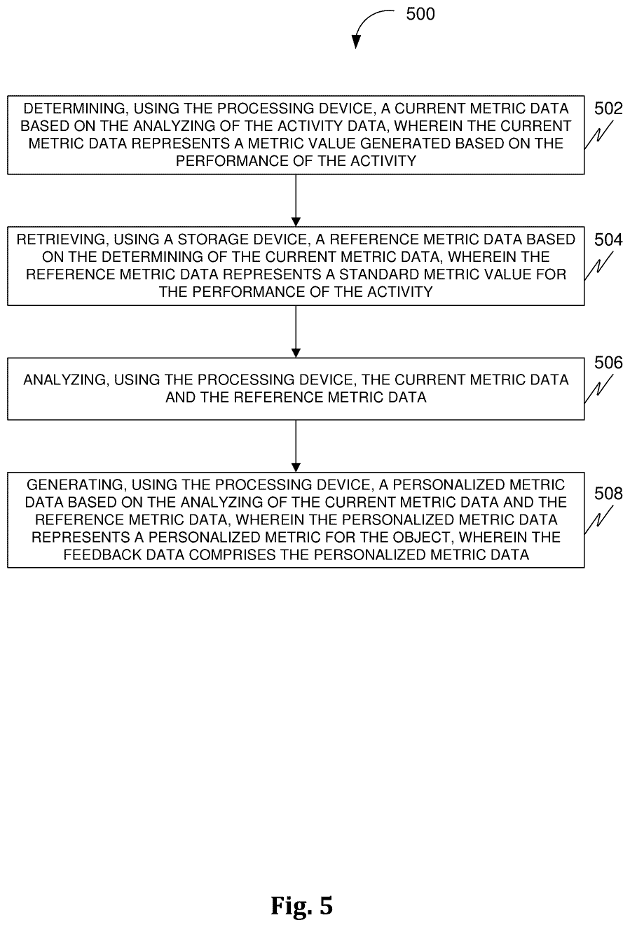

FIG. 5 illustrates a flowchart of a method 500 for provisioning a spatio-temporal feedback based on an activity including generating, using the processing device 604, a personalized metric data, in accordance with some embodiments. Further, in some embodiments, the method 500 further may include a step 502 of determining, using the processing device 604, a current metric data based on the analyzing of the activity data. Further, the current metric data represents a metric value generated based on the performance of the activity. Further, in some embodiments, the method 500 further may include a step 504 of retrieving, using a storage device 606, a reference metric data based on the determining of the current metric data. Further, the reference metric data represents a standard metric value for the performance of the activity. Further, in some embodiments, the method 500 further may include a step 506 of analyzing, using the processing device 604, the current metric data and the reference metric data. Further, in some embodiments, the method 500 further may include a step 508 of generating, using the processing device 604, a personalized metric data based on the analyzing of the current metric data and the reference metric data. Further, the personalized metric data represents a personalized metric for the object. Further, the feedback data includes the personalized metric data.

In some embodiments, the spatial characteristic data includes one or more of an alignment data representing an alignment of the object and a positional data representing a position of the object relative to the performance of the activity.

In some embodiments, the spatial characteristic data includes a movement data representing a body part movement associated with the user. Further, the body part movement includes one or more of a shoulder movement corresponding to a movement of a shoulder of the user, a wrist movement corresponding to the movement of a wrist of the user, and a joint movement corresponding to the movement of a joint of the user. Further, the joint includes one or more of a wrist joint, a shoulder joint, a hip joint, and a knee joint.

In some embodiments, the spatial characteristic data represents a factor affecting the performance of the user. Further, the spatial characteristic data includes two or more spatial characteristic data associated with the two or more activity data. Further, the two or more spatial characteristic data include a first spatial characteristic data associated with a first time period and a second spatial characteristic data associated with a second time period. Further, the method 400 further includes generating, using the processing device 604, an adaptive score data based on each of the first spatial characteristic data and the second spatial characteristic data. Further, the adaptive score data represents a score associated with the performance. Further, the feedback data includes the adaptive score data.

In some embodiments, the activity data further includes a positional shift data representing a positional shift of a body part of the user. Further, the positional shift includes a change in position of the body part from a first position to a second position.

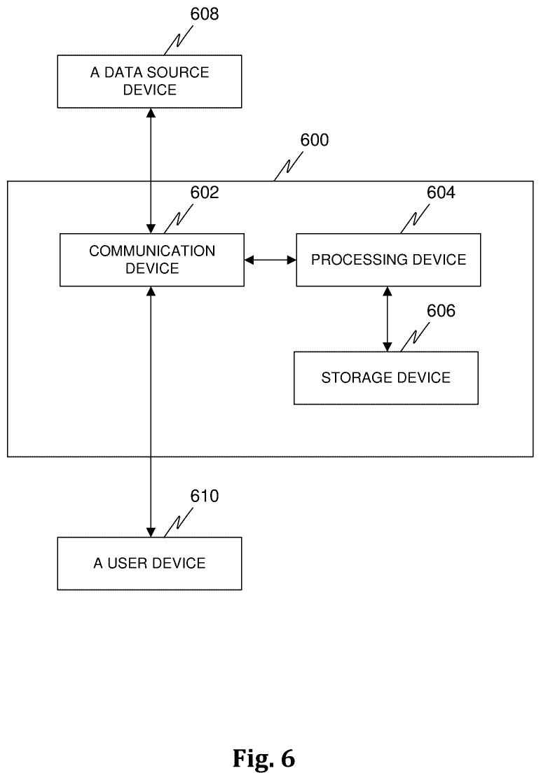

FIG. 6 illustrates a block diagram of a system 600 for provisioning a spatio-temporal feedback based on an activity, in accordance with some embodiments. Accordingly, the system 600 may include a communication device 602. Further, the communication device 602 may be configured for receiving an activity data from a data source device 608. Further, the activity data may be associated with a performance of the activity. Further, the communication device 602 may be configured for transmitting a feedback data to a user device 610 associated with a user. Further, the system 600 may include a processing device 604 communicatively coupled with the communication device 602. Further, the processing device 604 may be configured for analyzing the activity data using a spatial orientation model. Further, the spatial orientation model corresponds to a model representing a spatial orientation of an object associated with the activity. Further, the processing device 604 may be configured for determining a spatial characteristic data based on the analyzing. Further, the spatial characteristic data represent a spatial characteristic of the object. Further, the object includes a user. Further, the processing device 604 may be configured for generating the feedback data based on the determining of the spatial characteristic.

In some embodiments, the spatial orientation model includes one or more of a quaternion model and a three-dimensional mathematical model.

In some embodiments, the activity may be associated with two or more objects. Further, the feedback data includes an object data corresponding to the object. Further, the object further includes a sport equipment.

In some embodiments, the activity data includes two or more activity data corresponding to two or more activity phases. Further, the two or more activity phases include a first activity phase associated with a first time period and a second activity phase associated with a second time period. Further, the second time period occurs later than the first time period. Further, the generating of the feedback data includes generating a transition data based on each of the first activity phase and the second activity phase. Further, the transition data represent a transition from the first activity phase to the second activity phase.

In some embodiments, the processing device 604 may be further configured for computing a transition metric based on the transition data. Further, the transition metric corresponds to the transition associated with the performance of the activity. Further, the transition includes one or more of a rotational transition and a positional transition of the object relative to the activity.

Further, in some embodiments, the processing device 604 may be further configured for determining a current metric data based on the analyzing of the activity data. Further, the current metric data represents a metric value generated based on the performance of the activity. Further, the processing device 604 may be further configured for analyzing the current metric data and a reference metric data. Further, the processing device 604 may be further configured for generating a personalized metric data based on the analyzing of the current metric data and the reference metric data. Further, the personalized metric data represents a personalized metric for the object. Further, the feedback data includes the personalized metric data. Further, the system 600 further includes a storage device 606 communicatively coupled with the processing device 604. Further, the storage device 606 may be configured for retrieving a reference metric data based on the determining of the current metric data. Further, the reference metric data represents a standard metric value for the performance of the activity.

In some embodiments, the spatial characteristic data includes one or more of an alignment data representing an alignment of the object and a positional data representing a position of the object relative to the performance of the activity.

In some embodiments, the spatial characteristic data includes a movement data representing a body part movement associated with the user. Further, the body part movement includes one or more of a shoulder movement corresponding to a movement of a shoulder of the user, a wrist movement corresponding to the movement of a wrist of the user, and a joint movement corresponding to the movement of a joint of the user. Further, the joint includes one or more of a wrist joint, a shoulder joint, a hip joint, and a knee joint.

In some embodiments, the spatial characteristic data represents a factor affecting the performance of the user. Further, the spatial characteristic data includes two or more spatial characteristic data associated with the two or more activity data. Further, the two or more spatial characteristic data include a first spatial characteristic data associated with a first time period and a second spatial characteristic data associated with a second time period. Further, the processing device 604 may be further configured for generating an adaptive score data based on each of the first spatial characteristic data and the second spatial characteristic data. Further, the adaptive score data represents a score associated with the performance. Further, the feedback data includes the adaptive score data.

In some embodiments, the activity data further includes a positional shift data representing a positional shift of a body part of the user. Further, the positional shift includes a change in the position of the body part from a first position to a second position.

In some embodiments, the spatial orientation model exhibits an immunity to a gimbal locking issue.

In some embodiments, the generating of the feedback data further includes generating the feedback data using the spatial orientation model.

In some embodiments, the method 400 may further include analyzing, using the processing device 604, the spatial characteristic data. Further, the generating of the feedback data may be further based on the analyzing of the spatial characteristic data.

In some embodiments, the alignment data includes a posture data representing a posture associated with the user.

In some embodiments, the feedback data includes a body misalignment data corresponding to a body misalignment of the user relative to the performance of the activity.

In some embodiments, the spatial characteristic data further includes an orientation data representing an orientation of the object.

In some embodiments, the spatial characteristic data further includes a rotational data representing a rotational movement of the object.

In some embodiments, the body part movement data includes a micro-level movement data representing a micro level movement of the user relative to the activity.

In some embodiments, the micro-level movement includes a wrist rotation.

In some embodiments, the body part movement data includes a macro-level movement data representing a macro level movement associated with the activity.

In some embodiments, the macro-level movement includes one or more of a full body rotation and a full body alignment.

In some embodiments, the spatial characteristic data further includes a shooting angle data corresponding to a shooting angle associated with the user relative to the activity.

In some embodiments, the spatial characteristic data further includes a wrist rotation data representing a wrist rotation action associated with the user relative to the activity.

In some embodiments, the factor corresponds to a point scored by the user.

In some embodiments, the factor corresponds to a speed of the user.

In some embodiments, the factor corresponds to an accuracy of the user.

In some embodiments, the factor corresponds to a skill level of the user.

In some embodiments, the activity includes a sporting event.

In some embodiments, the sporting event includes basketball.

In some embodiments, the activity data further includes a shot data representing a shot phase associated with the activity.

In some embodiments, the shot phase includes one or more of a transfer phase, a pocket phase, and a release phase.

In some embodiments, the sporting includes football.

In some embodiments, the activity data further includes a rotational data representing a rotational action of the user.

In some embodiments, the sporting event includes hockey.

In some embodiments, the activity data further includes a user position data representing a position of the user in relation to a field in which the activity may be performed.

In some embodiments, the user includes a goal keeper.

In some embodiments, the sporting event further includes one or more of a swimming session, a gymnastic session, a cycling event, a weightlifting event, tennis, cricket, baseball, and an athletic event.

In some embodiments, the activity further includes one or more of a yoga session, a martial art, a dance session, an art session, and a cooking session.

In some embodiments, the feedback data further includes an adaptive insight data representing an adaptive insight based on a movement of a body part of the user relative to the activity.

In some embodiments, the user device 610 includes a coach device associated with a coach.

In some embodiments, the sport equipment includes one or more of a ball, a hockey stick, and a baseball bat.

In some embodiments, the object data includes a sports-mechanics data representing a mechanics of the sports equipment associated with the activity.

In some embodiments, the object data includes an object placement data representing a placement of the object during the performance of the activity.

In some embodiments, the object placement data includes an object angle data representing the angle at which the object may be positioned during the performance of the activity.

In some embodiments, the object includes a hockey stick. Further, the angle includes the hockey stick angle during a slap shot associated with the activity.

In some embodiments, the object placement data further includes an object interaction data representing an interaction of the object with each of the two or more objects.

In some embodiments, the object data further includes a grip adjustment data representing a grip adjustment for the object based on the activity.

FIG. 7 illustrates a display device 700 showing the integration of spatio-temporal data, in accordance with some embodiments. Further, the spatio-temporal data may include one or more of a shooting angle (702 and 704), a shooting distance 706, and a shooter elevation 708 relative to the activity.

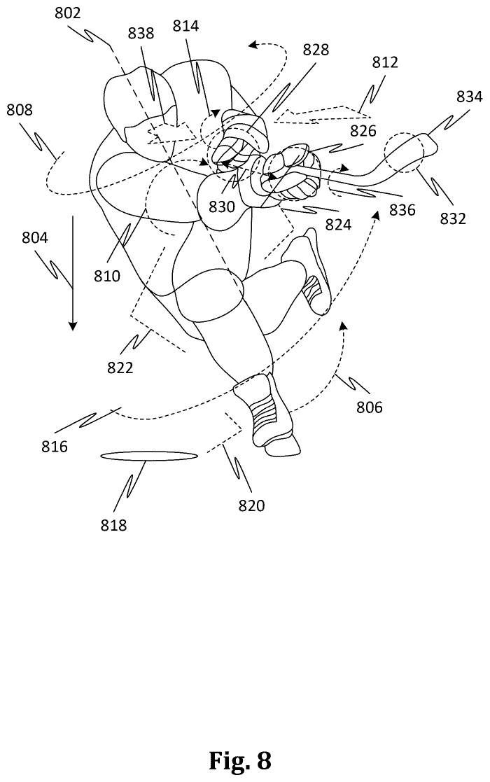

FIG. 8 illustrates a spatio-temporal mechanics of a player playing hockey, in accordance with some embodiments. Further, the spatial-temporal mechanics represents center of balance 802, transfer of weight 804, outside leg action 806, shoulder rotation 808, rotation of bottom arm 810, pull of top arm (flexion) 812, rotation of top hand 814, stick path 816, puck position 818, ankle flexion inside leg 820, knee flexion inside leg 822, hip flexion inside leg 824, grip bottom hand 826, grip top hand 828, width of hands 830, puck impact point 832, tip control (to target) 834, shaft rotation (⅛-¼turn) 836, targeting—focus 838.

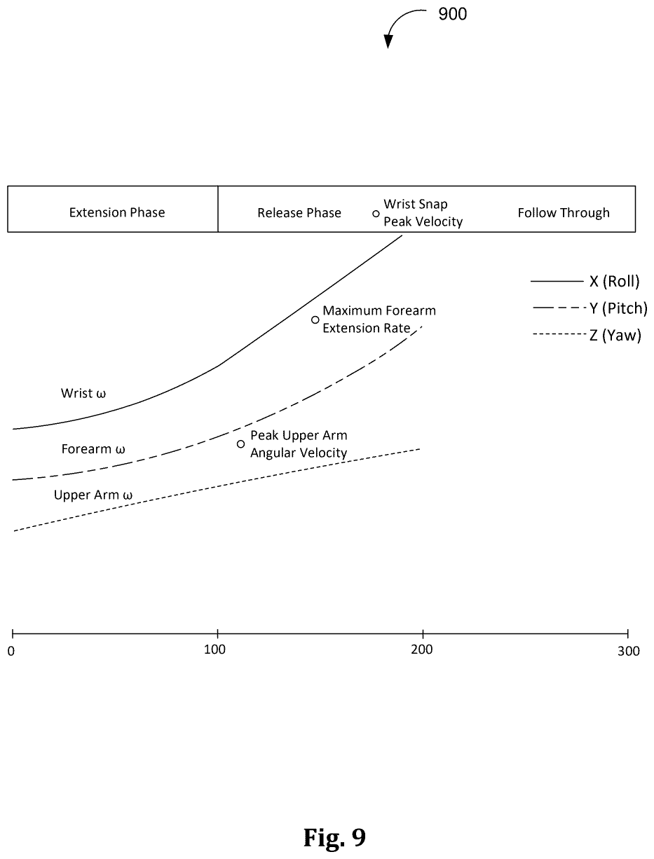

FIG. 9 illustrates a graph 900 of quaternion rotation dynamics, in accordance with some embodiments. Further, the graph 900 depicts a change in the quaternion rotation dynamics associated with a basketball shot release. Further, the graph 900 depicts the change in the quaternion rotation dynamics across two or more phases of the basketball shot release. Further, the two or more phases comprise an extension phase, a release phase, and a follow-through phase. Further, the quaternion rotation dynamics correspond to a wrist, a forearm, and an upper arm of a player performing the basketball shot release. Further, the quaternion rotation dynamics comprises one or more of a peak upper arm angular velocity, a maximum forearm extension rate, and a wrist snap peak velocity.

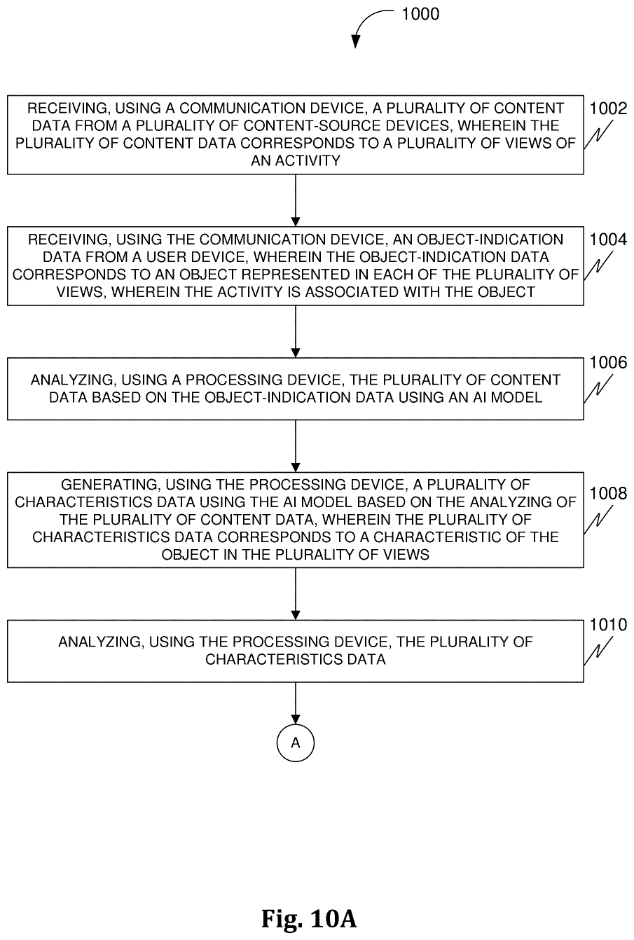

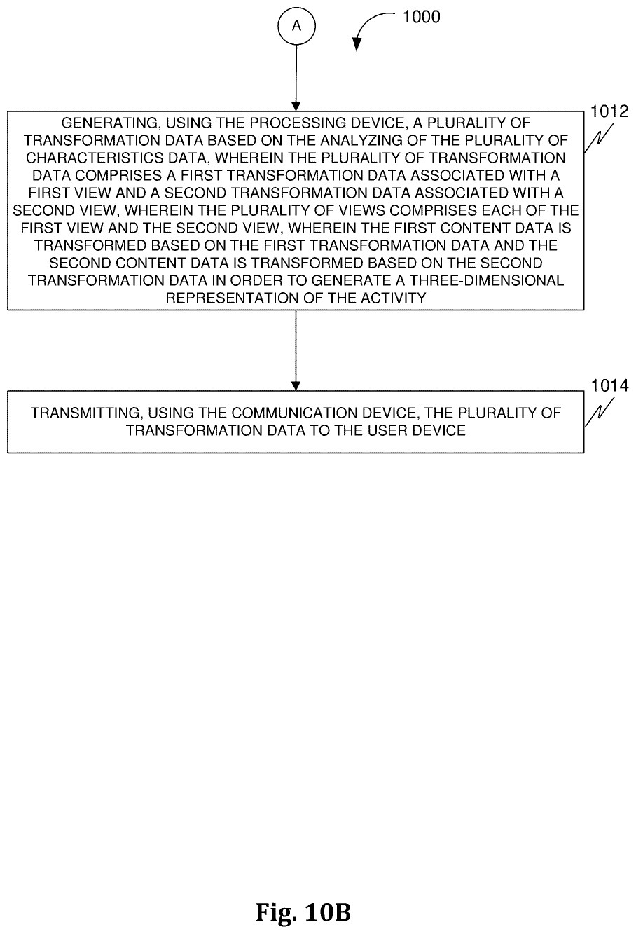

FIG. 10A and FIG. 10B illustrate a flowchart of a method 1000 of facilitating a calibration of multiple cameras, in accordance with some embodiments. Further, the method 1000 may include a step 1002 of receiving, using a communication device 1202, two or more content data from two or more content-source devices. Further, the two or more content data correspond to two or more views of an activity. Further, the method 1000 may include a step 1004 of receiving, using the communication device 1202, an object-indication data from a user device. Further, the object-indication data corresponds to an object represented in each of the two or more views. Further, the activity may be associated with the object. Further, the method 1000 may include a step 1006 of analyzing, using a processing device 1204, the two or more content data based on the object-indication data using an AI model. Further, the method 1000 may include a step 1008 of generating, using the processing device 1204, two or more characteristics data using the AI model based on the analyzing of the two or more content data. Further, the two or more characteristics data corresponds to a characteristic of the object in the two or more views. Further, the method 1000 may include a step 1010 of analyzing, using the processing device 1204, the two or more characteristics data. Further, the method 1000 may include a step 1012 of generating, using the processing device 1204, two or more transformation data based on the analyzing of the two or more characteristics data. Further, the two or more transformation data includes a first transformation data associated with a first view and a second transformation data associated with a second view. Further, the two or more views include each of the first view and the second view. Further, the first content data may be transformed based on the first transformation data and the second content data may be transformed based on the second transformation data in order to generate a three-dimensional representation of the activity. Further, the method 1000 may include a step 1014 of transmitting, using the communication device 1202, the two or more transformation data to the user device.

In some embodiments, the user device may be associated with a presentation device. Further, the presentation device may be configured to present a Graphical User Interface. Further, the user device may be configured to generate the object-indication data based on an interaction of the user with the Graphical User Interface.

In some embodiments, the Graphical User Interface includes the two or more content data. Further, the interaction corresponds to a physical interaction corresponding to a manual-click on the object in one or more of two or more views.

In some embodiments, the analyzing of the two or more content data includes extracting an object data from the two or more content data. Further, the object data corresponds to the object. Further, each of the two or more content data includes the object data.

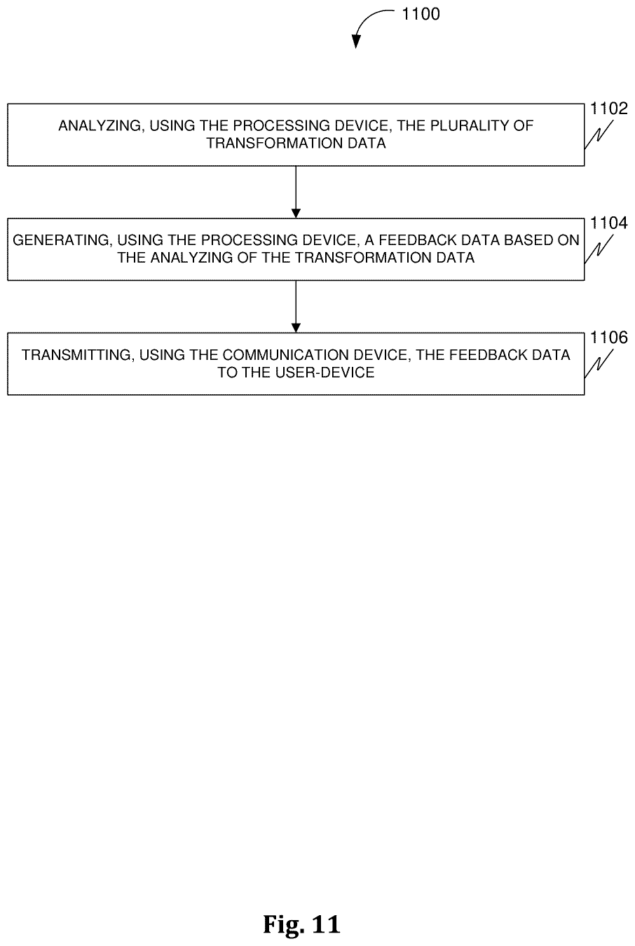

FIG. 11 illustrates a flowchart of a method 1100 of facilitating a calibration of multiple cameras including generating, using the processing device 1204, a feedback data, in accordance with some embodiments. Further, in some embodiments, the method 1100 further may include a step 1102 of analyzing, using the processing device 1204, the two or more transformation data. Further, in some embodiments, the method 1100 further may include a step 1104 of generating, using the processing device 1204, a feedback data based on the analyzing of the two or more transformation data. Further, in some embodiments, the method 1100 further may include a step 1106 of transmitting, using the communication device 1202, the feedback data to the user device.

In some embodiments, the two or more transformation data may include two or more matrices. Further, the two or more matrices may include two or more sets of values representing the object based on the two or more views.

In some embodiments, the two or more matrices may include an extrinsic matrix. Further, the two or more sets of values include an extrinsic set of values. Further, an extrinsic set of values represents an extrinsic characteristic of one or more of the two or more cameras.

In some embodiments, the two or more matrices may include an intrinsic matrix. Further, the two or more sets of values include an intrinsic set of values. Further, an intrinsic set of values represents an intrinsic characteristic of one or more of the two or more cameras.

In some embodiments, the method 1000 may further include storing, using a storage device 1206, the two or more transformation data in a database.

In some embodiments, the database includes two or more intrinsic data corresponding to the two or more content-source devices.

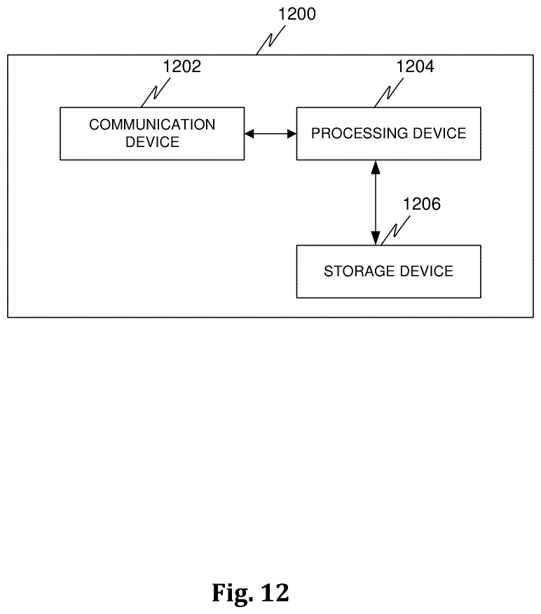

FIG. 12 illustrates a block diagram of a system 1200 of facilitating a calibration of multiple cameras, in accordance with some embodiments. Further, the system 1200 may include a communication device 1202. Further, the communication device 1202 may be configured for receiving two or more content data from two or more content-source devices. Further, the two or more content data correspond to two or more views of an activity. Further, the communication device 1202 may be configured for receiving an object-indication data from a user device. Further, the object-indication data corresponds to an object represented in each of the two or more views. Further, the activity may be associated with the object. Further, the communication device 1202 may be configured for transmitting two or more transformation data to the user device. Further, the system 1200 may include a processing device 1204 communicatively coupled with the communication device 1202. Further, the processing device 1204 may be configured for analyzing the two or more content data based on the object-indication data using an AI model. Further, the processing device 1204 may be configured for generating two or more characteristic data using the AI model based on the analyzing of the two or more content data. Further, the two or more characteristics data corresponds to a characteristic of the object in the two or more views. Further, the processing device 1204 may be configured for analyzing the two or more characteristics data. Further, the processing device 1204 may be configured for generating the two or more transformation data based on the analyzing of the two or more characteristic data. Further, the two or more transformation data includes a first transformation data associated with a first view and a second transformation data associated with a second view. Further, the two or more views include each of the first view and the second view. Further, the first content data may be transformed based on the first transformation data, and the second content data may be transformed based on the second transformation data in order to generate a three-dimensional representation of the activity.

In some embodiments, the user device may be associated with a presentation device. Further, the presentation device may be configured to present a Graphical User Interface. Further, the user device may be configured to generate the object-indication data based on an interaction of the user with the Graphical User Interface.

In some embodiments, the Graphical User Interface includes the two or more content data. Further, the interaction corresponds to a physical interaction corresponding to a manual-click on the object in one or more of two or more views.

In some embodiments, the analyzing of the two or more content data includes extracting an object data from the two or more content data. Further, the object data corresponds to the object. Further, each of the two or more content data includes the object data.

Further, in some embodiments, the processing device 1204 may be further configured for analyzing the two or more transformation data. Further, the processing device 1204 may be further configured for generating a feedback data based on the analyzing of the two or more transformation data. Further, the communication device 1202 may be further configured for transmitting the feedback data to the user device.

In some embodiments, the two or more transformation data may include two or more matrices. Further, the two or more matrices may include two or more sets of values representing the object based on the two or more views.

In some embodiments, the two or more matrices may include an extrinsic matrix. Further, the two or more sets of values include an extrinsic set of values. Further, an extrinsic set of values represents an extrinsic characteristic of one or more of the two or more cameras.

In some embodiments, the two or more matrices may include an intrinsic matrix. Further, the two or more sets of values include an intrinsic set of values. Further, an intrinsic set of values represents an intrinsic characteristic of one or more of the two or more cameras.

In some embodiments, the system 1200 may further include a storage device 1206 communicatively coupled with the processing device. Further, the storage device 1206 may be configured for storing the two or more transformation data in the database.

In some embodiments, the database includes two or more intrinsic data corresponding to the two or more content-source devices.

In some embodiments, the Graphical User Interface includes the two or more content data. Further, the interaction corresponds to a physical interaction. Further, the physical interaction includes two or more manual-clicks on the object in the two or more views.

In some embodiments, the user-device may be configured to execute one or more of an application and a browser. Further, each of the application and the browser may be configured to present the two or more views of the activity.

In some embodiments, the user device may include a mobile device.

In some embodiments, the two or more content-source devices may include two or more cameras.

In some embodiments, the two or more content data may include two or more images.

In some embodiments, the two or more content data may include two or more videos.

In some embodiments, the characteristic of the object corresponds to a contour of the object. Further, the contour corresponds to an outline of the object representing a shape of the object.

In some embodiments, the characteristic of the object corresponds to a center point of the object. Further, the center point may be located at a center of the object with respect to the contour.

In some embodiments, the two or more characteristics data includes each of a first characteristic data and a second characteristic data. Further, the first characteristic data corresponds to the first view associated with a first content-source device. Further, the second characteristic data corresponds to the second view associated with a second content-source device. Further, the two or more content-source devices include each of the first content-source device and the second content-source device.

In some embodiments, the first transformation data may be based on the first characteristic data, and the second transformation data may be based on the second characteristic data.

In some embodiments, the object may include a ball.

In some embodiments, the object may include a basketball.

In some embodiments, the extrinsic characteristic corresponds to one or more of a position of one or more of the two or more cameras and an orientation of one or more of the two or more cameras.

In some embodiments, the intrinsic characteristic corresponds to a focal length of one or more of the two or more cameras.

In some embodiments, the AI model includes an AI segmentation model.

In some embodiments, the analyzing of the two or more characteristic data includes comparing the first characteristic data with the second characteristic data. Further, the generating of the two or more transformation data may be based on the comparing of the first characteristic data with the second characteristic data.

In some embodiments, the generating of the two or more transformation data comprises performing a calculation based on the comparing of the first characteristic data with the second characteristic data.

In some embodiments, the extrinsic matrix includes a translation matrix corresponding to a position of one or more of the two or more content-source devices.

In some embodiments, the extrinsic matrix includes a rotation matrix corresponding to an orientation of one or more of the two or more content-source devices.

In some embodiments, the method 1000 may further include retrieving, using a storage device 1206, the two or more intrinsic data based on the analyzing of the two or more characteristic data. Further, the generating of the two or more transformation data may be further based on retrieving of the two or more intrinsic data.

In some embodiments, the two or more intrinsic data correspond to two or more intrinsic characteristics corresponding to the two or more content-source devices.

In some embodiments, the focal length corresponds to a distance between a sensor and a lens. Further, each of the two or more content-source devices includes each of the sensor and the lens.

In some embodiments, the sensor of the two or more content-source devices may be configured to generate two or more sensor data based on an environment. Further, the two or more content-source devices may be associated with the environment.

In some embodiments, the lens corresponds to a transparent optical component. Further, the transparent optical component may be configured to focus a light from the environment onto the sensor.

In some embodiments, the feedback data represents an accuracy of an alignment of the two or more content-source devices.

In some embodiments, the analyzing of the two or more transformation data includes validating the two or more transformation data based on one or more validation processes.

In some embodiments, the object comprises a pre-designated object. Further, the pre-designated object comprises a standard reference object.

In some embodiments, the method 1000 may further include receiving, using the communication device 1202, a user-interaction data from the user device. Further, the user-interaction data corresponds to a user interaction with the user device. Further, the analyzing of the two or more content data may be based on the user-interaction data.

In some embodiments, the user device may be associated with a presentation device. Further, the presentation device may be configured to present a Graphical User Interface. Further, the user interaction corresponds to a physical interaction between the user and the Graphical User Interface.

In some embodiments, the Graphical User Interface represents a text data. Further, the user interaction corresponds to a physical interaction of the user with the text data. Further, the physical interaction includes a manual-click on the text data.

In some embodiments, the text data includes a word “Calibrate”.

In some embodiments, the pre-designated object corresponds to a double-side calibration board. Further, the double-side calibration board includes a front side and a back side. Further, each of the front side and the back side includes a ChArUco pattern.

In some embodiments, the ChArUco pattern includes each of a checkerboard pattern and an Augmented Reality marker.

In some embodiments, the checkerboard pattern includes two or more black and white squares. Further, the two or more black and white squares may be arranged in a grid pattern.

In some embodiments, the Augmented Reality marker includes two or more Augmented Reality markers. Further, each of the two or more Augmented Reality markers corresponds to a unique identifier.

In some embodiments, each of the two or more Augmented Reality markers may be positioned at the center of each of the two or more black and white squares.

In some embodiments, a position of the two or more black and white squares may be identified based on each of the Augmented Reality markers and the checkerboard pattern.

In some embodiments, the characteristic corresponds to the position of the two or more black and white squares.

In some embodiments, the characteristic corresponds to two or more corners of the two or more black and white squares.

In some embodiments, the two or more cameras include four cameras.

In some embodiments, the two or more cameras include sixteen cameras.

In some embodiments, the method 1000 may further include generating, using the processing device 1204, a three-dimensional object data based on the two or more transformation data. Further, the three-dimensional object data corresponds to a three-dimensional model of the object. Further, the method 1000 may further include transmitting, using the communication device 1202, the three-dimensional object data to the user device.

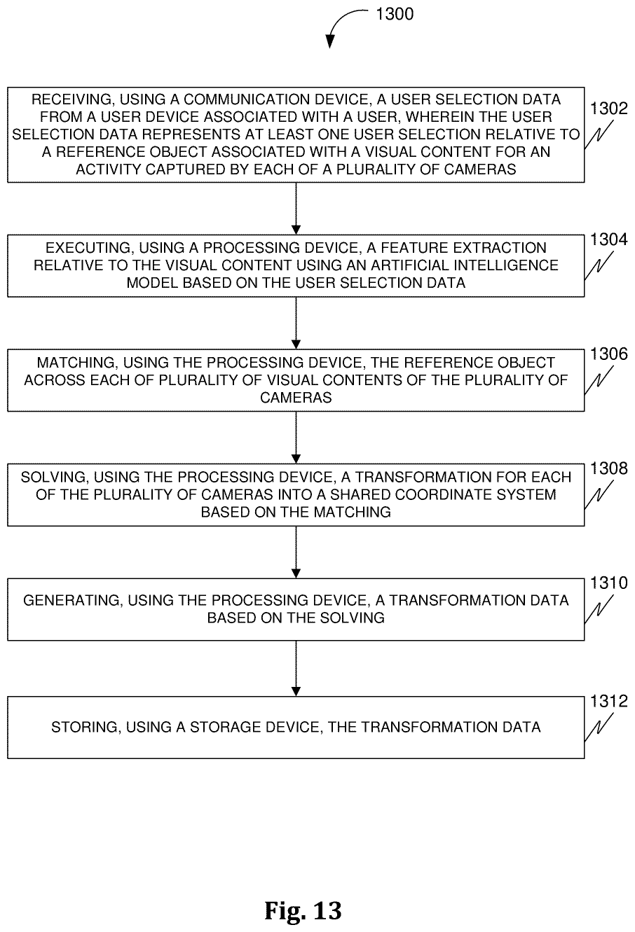

FIG. 13 illustrates a flowchart of a method 1300 for streamlining calibration of multiple cameras, in accordance with some embodiments. Accordingly, the method 1300 may include a step 1302 of receiving, using a communication device 1502, a user selection data from a user device associated with a user. Further, the user selection data represents one or more user selections relative to a reference object associated with a visual content for an activity captured by each of two or more cameras. Further, the method 1300 may include a step 1304 of executing, using a processing device 1504, a feature extraction relative to the visual content using an artificial intelligence model based on the user selection data. Further, the method 1300 may include a step 1306 of matching, using the processing device 1504, the reference object across each of two or more visual contents of the two or more cameras. Further, the method 1300 may include a step 1308 of solving, using the processing device 1504, a transformation for each of the two or more cameras into a shared coordinate system based on the matching. Further, the method 1300 may include a step 1310 of generating, using the processing device 1504, a transformation data based on the solving. Further, the method 1300 may include a step 1312 of storing, using a storage device 1506, the transformation data.

In some embodiments, the user selection data includes a user tap-based selection data representing one or more tap-based selections from the user relative to the reference object relative to the visual content.

In some embodiments, the executing of the feature extraction includes performing a feature-based segmentation of the visual content based on the user selection data. Further, the matching of the reference object across each of two or more visual contents of the two or more cameras is further based on the performing of the feature-based segmentation of the visual content.

Further, in some embodiments, the reference object may include one or more features associated with visual content.

In some embodiments, the solving of the transformation for each of the two or more cameras includes estimating an extrinsic transformation associated with each of the two or more cameras.

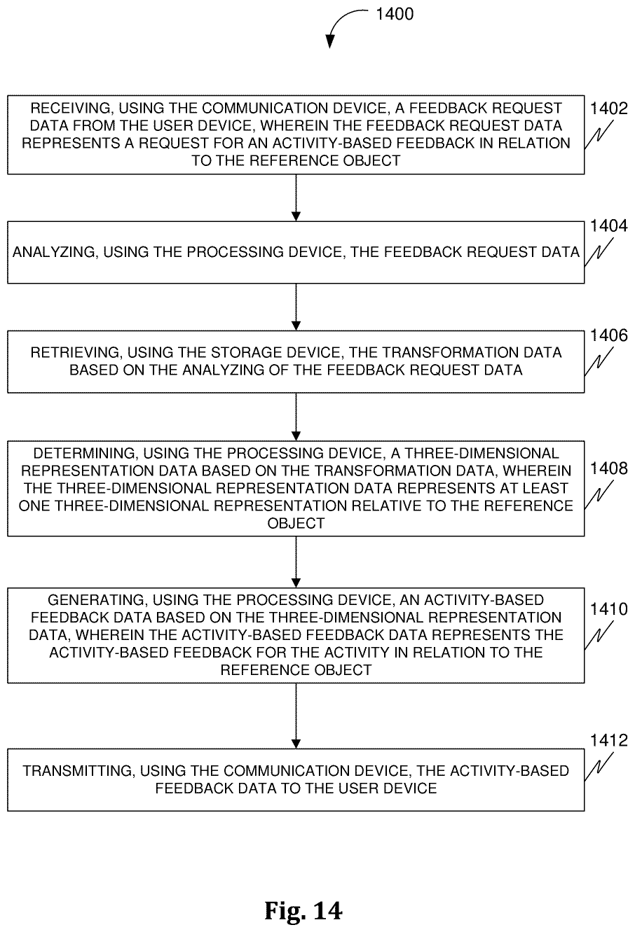

FIG. 14 illustrates a flowchart of a method 1400 for streamlining calibration of multiple cameras, including generating, using the processing device 1504, an activity-based data, in accordance with some embodiments. Further, in some embodiments, the method 1400 may further include a step 1402 of receiving, using the communication device 1502, a feedback request data from the user device. Further, the feedback request data represents a request for an activity-based feedback in relation to the reference object. Further, the method 1400 may further include a step 1404 of analyzing, using the processing device 1504, the feedback request data. Further, the method 1400 may further include a step 1406 of retrieving, using the storage device 1506, the transformation data based on the analyzing of the feedback request data. Further, the method 1400 may further include a step 1408 of determining, using the processing device 1504, a three-dimensional representation data based on the transformation data. Further, the three-dimensional representation data represents one or more three-dimensional representations relative to the reference object. Further, the method 1400 may further include a step 1410 of generating, using the processing device 1504, the activity-based feedback data based on the three-dimensional representation data. Further, the activity-based feedback data represents the activity-based feedback for the activity in relation to the reference object. Further, the method 1400 may include a step 1412 of transmitting, using the communication device 1502, the activity-based feedback data to the user device.

Further, in some embodiments, the method 1400 may further include storing, using the storage device 1506, the activity-based feedback data.

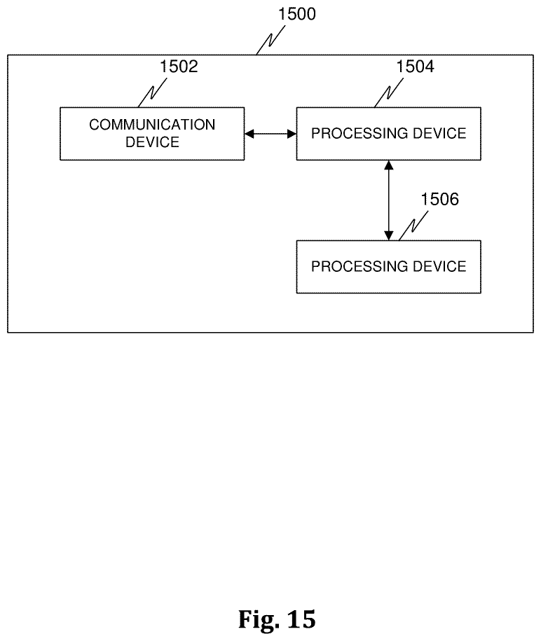

FIG. 15 illustrates a block diagram of a system 1500 for streamlining calibration of multiple cameras, in accordance with some embodiments. Accordingly, the system 1500 may include a communication device 1502. Further, the communication device 1502 may be configured for receiving a user selection data from a user device associated with a user. Further, the user selection data represents one or more user selections relative to a reference object associated with a visual content for an activity captured by each of two or more cameras. Further, the system 1500 may include a processing device 1504 communicatively coupled with the communication device 1502. Further, the processing device 1504 may be configured for executing a feature extraction relative to the visual content using an artificial intelligence model based on the user selection data. Further, the processing device 1504 may be configured for matching the reference object across each of two or more visual contents of the two or more cameras. Further, the processing device 1504 may be configured for solving a transformation for each of the two or more cameras into a shared coordinate system based on the matching. Further, the processing device 1504 may be configured for generating a transformation data based on the solving. Further, the system 1500 may include a storage device 1506 communicatively coupled with the processing device 1504. Further, the storage device 1506 may be configured for storing the transformation data.

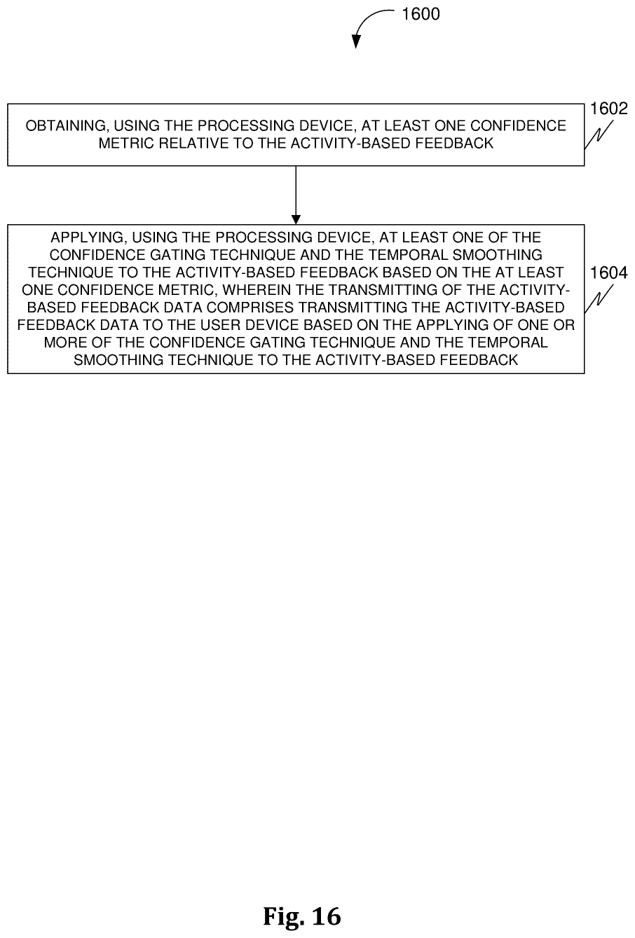

FIG. 16 illustrates a flowchart of a method 1600 for streamlining calibration of multiple cameras, including applying, using the processing device 1504, one or more of a confidence gating technique and a temporal smoothing technique to the activity-based feedback, in accordance with some embodiments. Further, in some embodiments, the method 1600 may further include a step 1602 of obtaining, using the processing device 1504, one or more confidence metrics relative to the activity-based feedback. Further, in some embodiments, the method 1600 may further include a step 1604 of applying, using the processing device 1504, one or more of the confidence gating technique and the temporal smoothing technique to the activity-based feedback based on the one or more confidence metrics. Further, the transmitting of the activity-based feedback data includes transmitting the activity-based feedback data to the user device based on the applying of one or more of the confidence gating technique and the temporal smoothing technique to the activity-based feedback.

Although the invention has been explained in relation to its preferred embodiment, it is to be understood that many other possible modifications and variations can be made without departing from the spirit and scope of the invention as hereinafter claimed.

What is claimed is:

1. A method for provisioning a spatio-temporal feedback based on an activity, the method comprising:
receiving, using a communication device, an activity data from a data source device, wherein the activity data is associated with a performance of the activity;
analyzing, using a processing device, the activity data using a spatial orientation model, wherein the spatial orientation model corresponds to a model representing a spatial orientation of an object associated with the activity;
determining, using the processing device, a spatial characteristic data based on the analyzing, wherein the spatial characteristic data represents a spatial characteristic of the object, wherein the object comprises a user;
generating, using the processing device, a feedback data based on the determining of the spatial characteristic; and
transmitting, using the communication device, the feedback data to a user device associated with a user.

2. The method of claim 1, wherein the spatial orientation model comprises at least one of a quaternion model and a three-dimensional mathematical model.

3. The method of claim 1, wherein the activity is associated with a plurality of objects, wherein the feedback data comprises an object data corresponding to the object, wherein the object further comprises a sport equipment.

4. The method of claim 1, wherein the activity data comprises a plurality of activity data corresponding to a plurality of activity phases, wherein the plurality of activity phases comprises a first activity phase associated with a first time period and a second activity phase associated with a second time period, wherein the second time period occurs later than the first time period, wherein the generating of the feedback data comprises generating a transition data based on each of the first activity phase and the second activity phase, wherein the transition data represents a transition from the first activity phase to the second activity phase.

5. The method of claim 4 further comprising computing, using the processing device, a transition metric based on the transition data, wherein the transition metric corresponds to the transition associated with the performance of the activity, wherein the transition comprises at least one of a rotational transition and a positional transition of the object relative to the activity.

6. The method of claim 4 further comprising:
determining, using the processing device, a current metric data based on the analyzing of the activity data, wherein the current metric data represents a metric value generated based on the performance of the activity;
retrieving, using a storage device, a reference metric data based on the determining of the current metric data, wherein the reference metric data represents a standard metric value for the performance of the activity;
analyzing, using the processing device, the current metric data and the reference metric data;
generating, using the processing device, a personalized metric data based on the analyzing of the current metric data and the reference metric data, wherein the personalized metric data represents a personalized metric for the object, wherein the feedback data comprises the personalized metric data.

7. The method of claim 1, wherein the spatial characteristic data comprises at least one of an alignment data representing an alignment of the object and a positional data representing a position of the object relative to the performance of the activity.

8. The method of claim 1, wherein the spatial characteristic data comprises a movement data representing a body part movement associated with the user, wherein the body part movement comprises at least one of a shoulder movement corresponding to a movement of a shoulder of the user, a wrist movement corresponding to the movement of a wrist of the user, and a joint movement corresponding to the movement of a joint of the user, wherein the joint comprises at least one of a wrist joint, a shoulder joint, a hip joint, and a knee joint.

9. The method of claim 4, wherein the spatial characteristic data represents a factor affecting the performance of the user, wherein the spatial characteristic data comprises a plurality of spatial characteristic data associated with the plurality of activity data, wherein the plurality of spatial characteristic data comprises a first spatial characteristic data associated with a first time period and a second spatial characteristic data associated with a second time period, wherein the method further comprises generating, using the processing device, an adaptive score data based on each of the first spatial characteristic data and the second spatial characteristic data, wherein the adaptive score data represents a score associated with the performance, wherein the feedback data comprises the adaptive score data.

10. The method of claim 1, wherein the activity data further comprises a positional shift data representing a positional shift of a body part of the user, wherein the positional shift comprises a change in position of the body part from a first position to a second position.

11. A system for provisioning a spatio-temporal feedback based on an activity, the system comprising:
a communication device configured for:
receiving an activity data from a data source device, wherein the activity data is associated with a performance of the activity; and
transmitting a feedback data to a user device associated with a user; and
a processing device communicatively coupled with the communication device, wherein the processing device is configured for:
analyzing the activity data using a spatial orientation model, wherein the spatial orientation model corresponds to a model representing a spatial orientation of an object associated with the activity;
determining a spatial characteristic data based on the analyzing, wherein the spatial characteristic data represents a spatial characteristic of the object, wherein the object comprises a user; and
generating the feedback data based on the determining of the spatial characteristic.

12. The system of claim 11, wherein the spatial orientation model comprises at least one of a quaternion model and a three-dimensional mathematical model.

13. The system of claim 11, wherein the activity is associated with a plurality of objects, wherein the feedback data comprises an object data corresponding to the object, wherein the object further comprises a sport equipment.

14. The system of claim 11, wherein the activity data comprises a plurality of activity data corresponding to a plurality of activity phases, wherein the plurality of activity phases comprises a first activity phase associated with a first time period and a second activity phase associated with a second time period, wherein the second time period occurs later than the first time period, wherein the generating of the feedback data comprises generating a transition data based on each of the first activity phase and the second activity phase, wherein the transition data represents a transition from the first activity phase to the second activity phase.

15. The system of claim 14, wherein the processing device is further configured for computing a transition metric based on the transition data, wherein the transition metric corresponds to the transition associated with the performance of the activity, wherein the transition comprises at least one of a rotational transition and a positional transition of the object relative to the activity.

16. The system of claim 14, wherein the processing device is further configured for:
determining a current metric data based on the analyzing of the activity data, wherein the current metric data represents a metric value generated based on the performance of the activity;
analyzing the current metric data and a reference metric data; and
generating a personalized metric data based on the analyzing of the current metric data and the reference metric data, wherein the personalized metric data represents a personalized metric for the object, wherein the feedback data comprises the personalized metric data, wherein the system further comprises a storage device communicatively coupled with the processing device, wherein the storage device is configured for retrieving a reference metric data based on the determining of the current metric data, wherein the reference metric data represents a standard metric value for the performance of the activity.

17. The system of claim 11, wherein the spatial characteristic data comprises at least one of an alignment data representing an alignment of the object and a positional data representing a position of the object relative to the performance of the activity.

18. The system of claim 11, wherein the spatial characteristic data comprises a movement data representing a body part movement associated with the user, wherein the body part movement comprises at least one of a shoulder movement corresponding to a movement of a shoulder of the user, a wrist movement corresponding to the movement of a wrist of the user, and a joint movement corresponding to the movement of a joint of the user, wherein the joint comprises at least one of a wrist joint, a shoulder joint, a hip joint, and a knee joint.

19. The system of claim 14, wherein the spatial characteristic data represents a factor affecting the performance of the user, wherein the spatial characteristic data comprises a plurality of spatial characteristic data associated with the plurality of activity data, wherein the plurality of spatial characteristic data comprises a first spatial characteristic data associated with a first time period and a second spatial characteristic data associated with a second time period, wherein the processing device is further configured for generating an adaptive score data based on each of the first spatial characteristic data and the second spatial characteristic data, wherein the adaptive score data represents a score associated with the performance, wherein the feedback data comprises the adaptive score data.

20. The system of claim 11, wherein the activity data further comprises a positional shift data representing a positional shift of a body part of the user, wherein the positional shift comprises a change in position of the body part from a first position to a second position.
